(19) United States
(12) Patent Application Publication
(10) Pub. No.: US 2026/0067427 A1
(43) Pub. Date: Mar. 5, 2026

(54) Intelligent User Interface Surveillance System and Method

(71) Applicant: Smart Home Sentry, Inc., dba Sentry AI, Sunnyvale, CA (US)

(72) Inventors: Uday Kiran Chaka, Sunnyvale, CA (US); Farhat Ali, Sunnyvale, CA (US); Thi Thanh Hien Nguyen, Sunnyvale, CA (US); Keshava Murali Elliadka, Bangalore (IN); Amit Sethi, Bangalore (IN); Smita Sasindran Pochappan, Bangalore (IN); Vasundhara Raj, Bangalore (IN); Nirmith Sunilkumar Rai, Bangalore (IN)

(21) Appl. No.: 19/317,362

(22) Filed: Sep. 3, 2025

Related U.S. Application Data
(60) Provisional application No. 63/689,871, filed on Sep. 3, 2024.

(51) Int. Cl. H04N 7/18; G06V 10/25; G06V 10/82; G06V 20/52; H04N 23/62

(52) U.S. Cl. CPC H04N 7/181; G06V 10/25; G06V 10/82; G06V 20/52; H04N 23/62

(57) ABSTRACT

An intelligent user interface surveillance system including an image processing engine (IPE) and a control unit is provided. The IPE receives an image stream from one or more image capture devices, identifies regions of interest and disinterest in the image stream; determines interest elements therein by selectively using one or more artificial intelligence (AI) modules; and generates resultant data based on the interest elements and one or more conditions. The control unit receives the resultant data from the IPE and selectively renders the resultant data in one or more views on an intelligent user interface (IUI) for review and verification. The IUI accepts tuning parameters for the image capture device(s) and the AI modules, and accepts identified false positives. The IPE updates the AI modules and the resultant data based on the tuning parameters and the refined false positives. The control unit executes response actions based on updated resultant data.

### CROSS-REFERENCE TO RELATED APPLICATIONS

This application claims priority to and the benefit of the provisional patent application titled “Human-in-loop Video Surveillance System and Graphical User Interface for Configuring, Operating, Monitoring, and Analyzing Effectiveness of an AI-assisted Video Surveillance”, application number 63/689,871, filed in the United States Patent and Trademark Office on Sep. 3, 2024. The specification of the above-referenced patent application is incorporated herein by reference in its entirety.

### BACKGROUND

Surveillance systems allow for real-time monitoring of premises, which helps in quickly identifying and responding to security breaches, emergencies, or unusual activities. Surveillance systems, therefore, assist in both preventing incidents and managing them effectively when they occur. A number of video surveillance systems employ video cameras that are installed in strategic locations around a surveillance area, for example, a city, a part of a city, a facility, a building, etc., for discouraging potential offenders and providing evidence in the event of a crime. Video footage from these cameras provides evidence, for example, for investigations, legal proceedings, etc., as they assist in identifying suspects, documenting events, and providing proof of actions taken during incidents. Moreover, video footage may be used to support insurance claims and resolve disputes related to accidents, damages, or other incidents. In businesses, video surveillance can monitor operations to ensure adherence to safety protocols, manage employee performance, and maintain quality control. Furthermore, in public spaces such as parks, streets, and transit systems, surveillance contributes to overall public safety by monitoring large areas and providing quick responses to emergencies.

Video surveillance may also be used as a strategy to secure physical assets. Manual monitoring of a live stream of video frames received from multiple video cameras is labor-intensive, expensive, and error-prone due to fatigue and monotony. While artificial intelligence (AI) may assist in filtering video frames in a live video feed where some regions and objects of interest are detected, surveillance systems based purely on AI, are substantially prone to false positive and false negative errors. Although a user may change various decision thresholds to reduce one type of error, another type of error may increase.

Hence, there is a long-felt need for an intelligent user interface (IUI) surveillance system and a method for facilitating IUI surveillance using a combination of various AI modules and user inputs that monitor and respond to AI-generated alerts.

### BRIEF DESCRIPTION OF THE DRAWINGS

The following detailed description of the invention is better understood when read in conjunction with the appended drawings. For illustrating the embodiments herein, exemplary constructions of the embodiments are shown in the drawings. However, the embodiments herein are not limited to the specific components, structures, and methods disclosed herein. The description of a component, or a structure, or a method step referenced by a numeral in a drawing is applicable to the description of that component or method step shown by that same numeral in any subsequent drawing herein.

FIG. 1 illustrates a block diagram of an intelligent user interface (IUI) surveillance system.

FIG. 2 illustrates a block diagram of an embodiment of a system for securing the IUI surveillance system.

FIG. 3 illustrates a flowchart of an embodiment of a method for facilitating IUI surveillance.

FIGS. 4A-4S illustrate screenshots of a user interface configured for rendering a comprehensive view of an image stream captured by one or more image capture devices and facilitating IUI surveillance.

FIGS. 5A-5D illustrate screenshots showing graphical user interfaces rendered by a mobile application deployed on a user device for facilitating IUI surveillance.

FIG. 6 illustrates an architectural block diagram of an exemplary implementation of an embodiment of the IUI surveillance system for facilitating IUI surveillance.

FIGS. 7A-7E illustrate screenshots of an image stream captured by video surveillance cameras and a user interface configured for rendering a comprehensive view facilitating IUI surveillance.

### DETAILED DESCRIPTION OF THE INVENTION

Various aspects of the disclosure herein are embodied as a system, a method, or a non-transitory, computer-readable storage medium having one or more computer-readable program codes stored thereon. Accordingly, various embodiments of the disclosure herein take the form of an entirely hardware embodiment, an entirely software embodiment comprising, for example, microcode, firmware, software, etc., or an embodiment combining software and hardware aspects that are referred to herein as a “system”, a “module”, an “engine”, a “circuit”, or a “unit”. The terms “first” and “second” are used herein for descriptive purposes only and are not to be construed to indicate or imply relative importance.

In one or more embodiments, related systems comprise circuitry and/or programming for executing the methods disclosed herein. The circuitry and/or programming comprise one or any combination of hardware, software, and/or firmware configured to execute the methods disclosed herein depending upon the design choices of a system designer. In an embodiment, various structural elements are employed depending on the design choices of the system designer.

The system and the method disclosed herein address the above-recited long-felt need for an intelligent user interface (IUI) surveillance system (IUISS) and a method for facilitating IUI surveillance using a combination of various artificial intelligence (AI) modules and user inputs that monitor and respond to AI-generated alerts. The IUI surveillance system (IUISS) and the method disclosed herein provide a multi-layered approach to video surveillance. The IUI surveillance system and the method disclosed herein combine image processing and AI algorithms comprising, for example, machine learning algorithms, with user feedback obtained using a specifically-configured Graphical User Interface (GUI), herein referred to as an “Intelligent User Interface (IUI)”, to enhance real-time monitoring and security of a surveillance area. The IUI surveillance system and its IUI are utilized for setting up, configuring, operating, monitoring, responding to AI-generated alerts, and analyzing history and various aspects of effectiveness of IUI video surveillance using one or multiple image capture devices, for example, cameras. The system disclosed herein uses a user in the loop along with a processing pipeline enabled by algorithms and artificial intelligence to reduce false positives at each stage of the pipeline, including the final decision made by the user.

The IUI surveillance system disclosed herein comprises mounted image capture devices connected to a data transfer mechanism, for example, cables or the internet, a motion detection system, computational modules including AI modules, users such as observers and responders (hereinafter referred to as “users”), and an intelligent user interface (IUI) to set up, configure, monitor, and analyze the effectiveness of IUI video surveillance. In an embodiment, the IUI allows the users in an intuitive manner to set up an account, configure image capture devices associated with the account, configure spatial and temporal parameters according to which AI will be applied to each image capture device, and select the AI modules to be applied to each image capture device. In various embodiments, the IUI allows the users to configure parameters of the AI modules, demonstrate a Standard Operating Procedure (SOP) to respond to an AI-generated alert, and manage and respond to the AI-generated alerts. In further embodiments, the IUI allows the users to set up automated or semi-automated responses to alerts, edit and demonstrate an SOP for responding to an alert, escalate or dispatch responses based on situational assessment, view a history of images and alerts associated with a particular image capture device, and analyze overall system behavior and statistics for assessment and improvement.

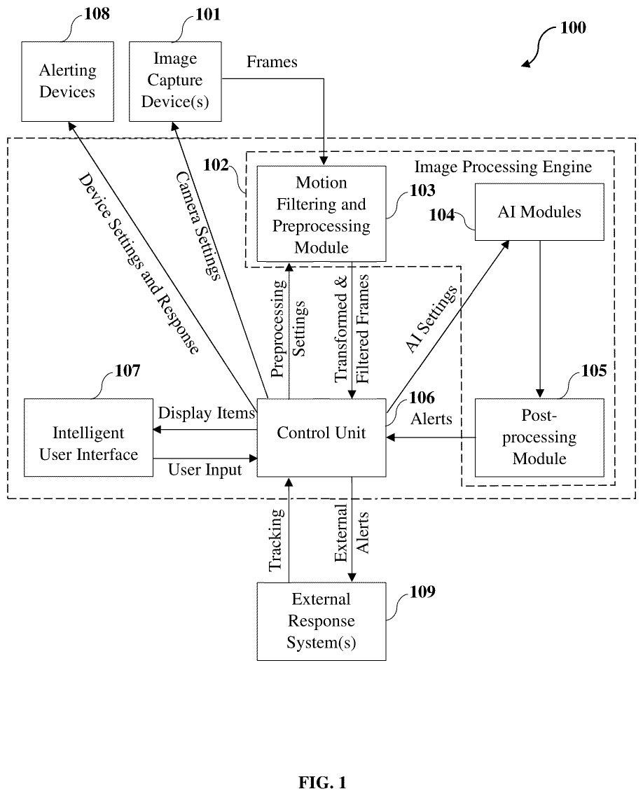

FIG. 1 illustrates a block diagram of an intelligent user interface (IUI) surveillance system 100. The IUI surveillance system 100 disclosed herein is an intelligent video surveillance system that integrates artificial intelligence (AI) with user oversight for improved security and efficiency. The IUI surveillance system 100 combines automated surveillance technologies with user inputs and insights to enhance monitoring, decision-making, and responses to alerts. In the IUI surveillance system 100, automated tools that are driven by AI and users operate together to achieve optimal outcomes. In an embodiment as illustrated in FIG. 1, the IUI surveillance system 100 comprises one or more image capture devices 101, an image processing engine 102, a control unit 106, and an intelligent user interface (IUI) 107. The image capture devices 101, for example, cameras, video cameras, web cameras, surveillance cameras, security cameras, fix-mount cameras, Pan-Tilt-Zoom (PTZ) cameras, image sensors, etc., are disposed in strategic locations around a surveillance area, for example, a city, a part of a city, a facility, a building, etc., that requires real-time monitoring and surveillance. In an embodiment, each image capture device 101 is attached to a fixed mount. In embodiments, each image capture device 101 is configured with a PTZ control. In additional embodiments, each image capture device 101 is configured with onboard intelligence to detect motion in their view. For example, each image capture device 101 is configured to transmit frames only when motion is detected based on its onboard processing. As used herein, the term ‘frames’ refers to ‘image frames,’ and the two terms are used interchangeably throughout the specification.

The image capture devices 101 are configured to capture an image stream associated with the surveillance area. As used herein, “image stream” refers to one or more images, or a continuous set of images captured by the image capture devices 101. The image stream comprises, for example, live video, individual frames, batches of frames, video clips, video feeds, etc. In an example, one or multiple cameras capture video footage of a surveillance area. The image capture devices 101 are further configured to selectively transmit the captured image stream via a network, for example, a wired network or a wireless network. In an embodiment, the image capture devices 101 transmit frames with motion or all frames captured. In an embodiment, the image capture devices 101 are configured to transmit image frames when a condition is met. For example, the image capture devices 101 transmit the image frames only when motion is detected in the image stream. In an embodiment, the image capture devices 101 transmit the captured image stream via one or more of multiple data transfer techniques, for example, via a video cable, Ethernet, or other methods of data transfer such as an internet connection, using any of multiple different data transfer protocols.

In an embodiment, the image capture devices 101 transmit the captured image stream to the image processing engine 102 hosted on at least one computer system, for example, a computing server (not shown in FIG. 1), via the network. The computing server is in operable communication with the image capture devices 101. In this embodiment, the image processing engine 102 is executable by at least one processor of the computing server. In another embodiment, the image processing engine 102 is configured as a computer system comprising a processor and a memory unit. The memory unit is operably and communicatively coupled to the processor and is configured to store computer program instructions, the image stream, and metadata associated with the image stream. The image processing engine 102 defining the computer program instructions, which is executed by the processor. The image processing engine 102 receives the image stream of the surveillance area from the image capture devices 101, by a motion filtering and pre-processing module of the image processing engine, via the network. In an embodiment, the image processing engine 102 is configured to receive the transmitted image stream from the image capture devices 101 via a mail transfer protocol, for example, Simple Mail Transfer Protocol (SMTP). In an embodiment, the image processing engine 102 comprises a motion filtering and preprocessing module 103, AI modules 104, and a post-processing module 105. In various embodiments, the motion filtering and preprocessing module 103, the AI modules 104, and the post-processing module 105 are configured as software modules stored in the memory of the image processing engine 102. In other embodiments, the motion filtering and preprocessing module 103 and the post-processing module 105 are configured as individual computer systems, each comprising a processor and a memory. The motion filtering and pre-processing module 103 and the post-processing module 105 are operably and communicatively coupled to the control unit 106 as illustrated in FIG. 1.

The motion filtering and pre-processing module 103 of the image processing engine 102 identifies regions of interest and regions of disinterest in the image stream. The regions of interest comprise, for example, regions of significant motion and user-specified regions of interest. The regions of disinterest comprise, for example, regions of no interest, regions outside physical boundaries of the surveillance area, and user-specified regions of disinterest. In an embodiment, the regions of interest and the regions of disinterest are one or more of user-specified or auto-suggested by an artificial intelligence system comprising neural networks that recognize the regions of interest and the regions of disinterest of the surveillance area. In an embodiment, the motion filtering and preprocessing module 103 of the image processing engine 102 performs image processing-based motion filtering. The motion filtering and preprocessing module 103 performs initial processing on image frames transmitted by the image capture devices 101. In an embodiment, the motion filtering and preprocessing module 103 performs initial processing on the image frames within a set schedule. In other embodiments, the motion filtering and preprocessing module 103 performs source validation by verifying that the images are received from authorized sources and that these sources are allowed to transmit images for processing. In further embodiments, the motion filtering and preprocessing module 103 performs consistency and quality checks of the received images to ensure that the images are fit for further processing. The consistency and quality checks comprise for example, checks for image data corruption, resolution, etc. In several embodiments, the motion filtering and preprocessing module 103 performs motion and region of interest overlap checks and processes the images only if the detected motion is within an identified region of interest.

The motion filtering and preprocessing module 103 employs image processing and machine learning algorithms to analyze the image frames, for example, video frames, from the received image stream and identify those image frames containing motion, which substantially reduces the amount of data requiring user review, focusing attention on potentially relevant events. The motion filtering and preprocessing module 103 identifies areas of significant motion to focus analysis, and further reduces false positives in motion detected by the onboard processing performed by the image capture devices 101. The motion filtering and preprocessing module 103 employs various motion detection techniques comprising, for example, utilization of two-dimensional (2-D) Fourier transforms or other transforms, histogram equalization, shape analysis of areas of significant pixel value difference between frames, inter-frame pixel value differencing, region-wise aggregation of differences, etc., for refined motion detection. In an embodiment, the motion filtering and preprocessing module 103 terminates processing of image batches or video clips if no significant motion is detected therein.

In an embodiment, the motion filtering and preprocessing module 103 performs region-wise motion filtering. The motion filtering and preprocessing module 103 utilizes user-specified regions of interest and regions of disinterest with each image capture device 101 to filter image frames with motion in only specific areas of their view. In other embodiments, the motion filtering and preprocessing module 103 performs image frame enhancement comprising, for example, noise reduction, contrast enhancement, region-adaptive contrast enhancement, brightness adaptation, etc., to improve image quality to improve performance of the AI modules. In an embodiment, the motion filtering and preprocessing module 103 further enhances the motion detection by using information from three consecutive image frames and processing their 2-D Fourier transforms for robust frame differencing that rejects false alarms in frame differences due to rain, snow, and changing light. The motion filtering and preprocessing module 103 transmits transformed and filtered image frames to the control unit 106 of the IUI surveillance system 100. The above-disclosed functions of the motion filtering and preprocessing module 103 include configurable settings that may be modified based on the requirements of the image capture devices 101 and the pipeline of AI modules 104. These settings are configured using the intelligent user interface (IUI) 107. The control unit 106 receives the settings for the motion filtering and preprocessing module 103 from the IUI 107 and transmits the settings to the motion filtering and preprocessing module 103.

The image processing engine 102 determines multiple interest elements in the identified regions of interest in the image stream by selectively using one or more of multiple AI modules 104, such as deep neural networks in the form of convolutional neural networks, transformer modules, etc. The interest elements in the identified regions of interest in the image stream comprise, for example, faces, humans, animals, vehicles, objects such as masks, markers such as license plate numbers, events, etc. The processing entities of the image processing engine 102, that is, the AI modules 104, such as the deep neural networks 104, are configured to perform specific tasks, for example, detection, recognition, and event detection. In an embodiment, the AI modules 104 are arranged as part of a directed acyclic graph with each of the entities acting as graph vertices, as some of the AI modules 104 have dependencies between them. For example, upon detecting motion an image capture device captures and transmits a burst of frames to the motion filtering and preprocessing module 103. The motion filtering and preprocessing module 103 processes the received burst of frames using 2-D Fourier transform to filter out spurious motion alerts triggered by movements such as shadows, insects, or swaying trees. The burst of frames thus filtered for motion are input into a convolutional neural network or transformer network of the AI modules 104 for the detection of humans and vehicles. If a human or vehicle is detected, these burst of frames are further input into a video analysis neural network for event and behavior detection or the event or behavior is detected based on hard-coded rules applied to the detection of objects, their locations, their motion in time, and their confidence scores to detect events of interest. In various embodiments, each of the AI modules 104 is customizable on a per-camera basis via the intelligent user interface (IUI) 107. The custom settings for the AI modules 104 comprise, for example, parameters such as a detection confidence threshold, a selection of deep learning models, overlap against motion boxes, etc. The control unit 106 receives the settings for the AI modules 104 from the IUI 107 and transmits the settings to the AI modules 104.

In an embodiment, the AI modules 104 employ machine learning algorithms to detect the presence of persons and vehicles within video frames of the image stream, thereby performing a targeted analysis and prioritizing events of higher security interest. The AI modules 104 receive the image frames pre-processed by the motion filtering and pre-processing module 103. In various embodiments, the AI modules 104 analyze the pre-processed image frames using a collection of selected AI models to generate alerts within a specified schedule. In an embodiment, one or more of the AI modules 104 identify the presence and location of humans within the identified regions of interest. In another embodiment, one or more of the AI modules 104 identify the presence and type of vehicles within the identified regions of interest. In another embodiment, one or more of the AI modules 104 identify the presence and type of objects within the identified regions of interest using a custom trained object detection neural network. In another embodiment, one or more of the AI modules 104 perform facial recognition and identify the presence of a face or faces within the identified regions of interest. In another embodiment, one or more of the AI modules 104 perform vehicle recognition and identify the presence of a vehicle or vehicles within the identified regions of interest. In another embodiment, one or more of the AI modules 104 perform vehicle license plate recognition and identify a license plate number of a detected vehicle. In another embodiment, one or more of the AI modules 104 perform event detection and identification of events of interest within the identified regions of interest. Examples of events of interest comprise loitering, fence jumping, person falling, etc.

In another embodiment, the artificial intelligence (AI) module 104 comprises a plurality of AI models and machine learning algorithms configured to perform one or more functions including, but not limited to, image processing, motion detection, and video surveillance. The AI models may include, without limitation, convolutional neural networks (CNNs), recurrent neural networks (RNNs), long short-term memory (LSTM) networks, generative adversarial networks (GANs), transformers, support vector machines (SVMs), k-nearest neighbours (KNN), decision trees, random forest models, and other ensemble learning techniques. The AI module 104 may be configured to perform image processing operations such as object detection (e.g., utilizing YOLO, SSD, or Faster R-CNN models), image segmentation (e.g., using U-Net or Mask R-CNN), and image classification using pretrained or custom-trained deep learning models. For motion detection, the AI module may employ methods such as optical flow, background subtraction augmented by neural networks, and temporal analysis using 3D CNNs or LSTM-based architectures. For video surveillance, the AI module may further include components for facial recognition, multi-object tracking, behaviour analysis, and anomaly detection, which may be implemented using supervised learning, unsupervised learning, and/or reinforcement learning techniques. Furthermore, the AI module 104 is trained using labelled and/or unlabelled datasets and may be configured to adaptively improve over time based on feedback or additional training data.

In an embodiment, the image processing engine 102 categorizes the determined interest elements. For example, in response to identifying the presence of a face or faces within the identified regions of interest, one or more of the AI modules 104 categorize the identified face or faces as known, unknown, or unidentifiable. In an embodiment, the AI module(s) 104 further classifies the known faces as trusted on a “Safe List”, or untrusted on a “Watch List”. In another example, in response to identifying the presence of a vehicle or vehicles within the identified regions of interest, one or more of the AI modules 104 categorize the identified vehicle or vehicles as known, unknown, or unidentifiable using elements, such as license plates, any text, logos, symbols, or other markers on the vehicle(s). In an embodiment, the AI module(s) 104 further classifies the known vehicles as trusted as defined on a “Safe List”, or untrusted as defined on a “Watch List”.

The image processing engine 102 generates resultant data based on the determined interest elements and one or more of multiple conditions, by the AI modules of the image processing engine. The conditions comprise, for example, configurable thresholds associated with overlaps between the determined interest elements and the identified regions of interest, overlaps between the determined interest elements and the identified regions of disinterest, location of the interest elements, size of the interest elements, type of the interest elements, number of the interest elements, time period of detections of the interest elements, configurable schedules, field of view changes, preferences of the user, etc. The resultant data comprises, for example, the identified regions of interest, the identified regions of disinterest, the determined interest elements, actionable alerts, tuning parameters, alert history, alert response history, alert response standard operating procedures, alert response statistics, information about behavior of an external response system, etc.

The post-processing module 105 of the image processing engine 102 receives and filters alerts generated by the AI modules 104. The post-processing module 105 receives and consolidates results from the pipeline of AI modules 104 and the motion filtering and preprocessing module 103 to generate relevant and actionable alerts. In an embodiment, the post-processing module 105 determines whether there is an overlap between motion and detection by determining whether the detected objects or events are in the region where motion is detected. The post-processing module 105 then generates an actionable alert only if there is an overlap above a configurable threshold. In another embodiment, the post-processing module 105 determines whether there is an overlap between an identified region of interest and the detected object(s). The post-processing module 105 generates an actionable alert only if the detected object(s) is within the identified region of interest. In another embodiment, the post-processing module 105 generates actionable alerts if a detected object is not overlapping with a region of disinterest or a blocked region. In another embodiment, the post-processing module 105 performs object size-based filtering by filtering out the alerts where the size of a detected object is too large or too small. In an embodiment, the filtering size thresholds are configurable and/or learned from historical patterns. In another embodiment, the post-processing module 105 removes object(s) detected outside the identified region of interest. In another embodiment, the post-processing module 105 removes object(s) detected within the identified region of disinterest.

In an embodiment, the post-processing module 105 performs multiple alert suppression by generating only one alert corresponding to multiple detections of the same type in a given video or image batch. The post-processing module 105 performs multiple alert suppression to avoid generating and sending too many alerts to users. In most cases, the videos or image batches generate multiple instances of detection. In another embodiment, the post-processing module 105 performs time-based alert suppression by avoiding generation of multiple alerts within a short time period. In another embodiment, a user may configure alert limit-based settings by configuring the number of alerts that the user wants to receive in a time period to avoid flooding of the alerts in a busy environment. The actionable alerts finalized by the post-processing module 105 constitute the generated resultant data. The post-processing module 105 transmits the generated resultant data to the control unit 106 of the IUI surveillance system 100. In an embodiment, the control unit 106 receives settings for the post-processing module 105 from the intelligent user interface (IUI) 107 and transmits the settings to the post-processing module 105. The settings for the post-processing module 105 comprise thresholds to filter alerts, holdoff time between alerts, alert suppression settings, etc.

The control unit 106 is in operable communication with the image processing engine 102 as illustrated in FIG. 1. The control unit 106 is a computational unit with a memory that passes settings on the intelligent user interface (IUI) 107 to various modules of the IUI surveillance system 100, for example, the image capture devices 101, the motion filtering and preprocessing module 103, the AI modules 104, and the alerting devices 108. Moreover, the control unit 106 passes the output of the various modules to the IUI 107, and passes selected alerts to an external response system 109. In an embodiment, the control unit 106 is configured to set various parameters of the image capture devices 101, the motion filtering and preprocessing module 103, the pipeline of AI modules 104, and the post-processing module 105. For example, the control unit 106 sets a frame rate for each of the image capture devices 101. In another example, the control unit 106 sets time schedule, sensitivity, etc., for the motion filtering and preprocessing module 103. In another example, the control unit 106 sets the AI models to be used, time schedule, sensitivity, etc., for the pipeline of AI modules 104. The control unit 106 transmits the AI settings to the AI modules 104. In another embodiment, the control unit 106 sets object-size based filtration, alert limits, overlap thresholds, etc., for the post-processing module 105.

The control unit 106 is configured to receive the generated resultant data from the image processing engine 102. The control unit 106 is further configured to selectively render the generated resultant data in one or more views on the intelligent user interface (IUI) 107 for review and verification. For example, the control unit 106 routes display items, that is, specific information of interest to the IUI surveillance system (IUISS) user via the IUI 107. The specific information of interest comprises, for example, a live camera view, a camera view image, clip history, camera settings, preprocessing settings, AI module settings, preprocessing and AI time schedules, regions of interest associated with each camera view, post-processing settings, alert history, alert response history, alert response standard operating procedures, alert response statistics, external response system behavior information, etc.

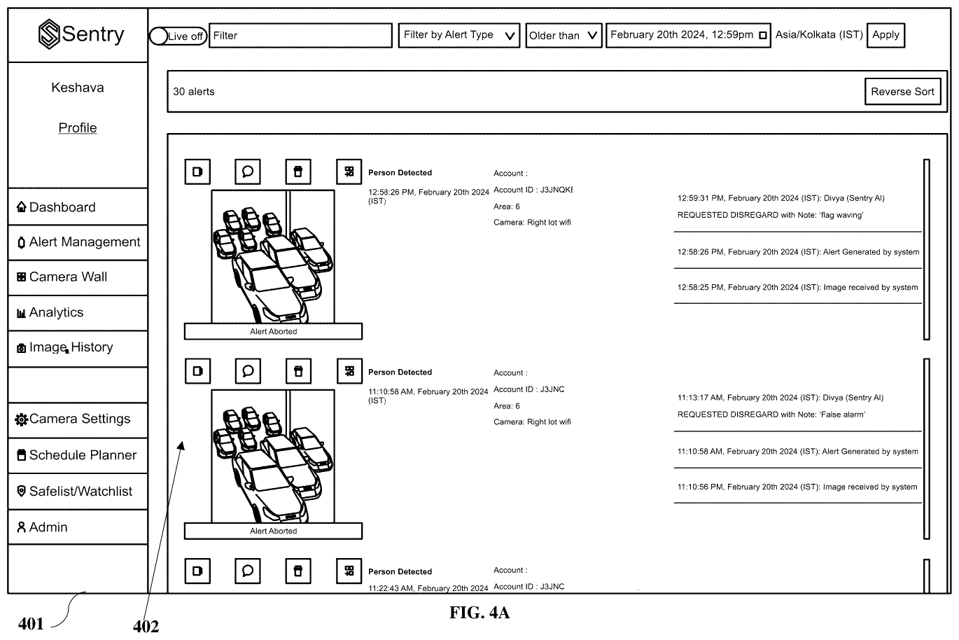

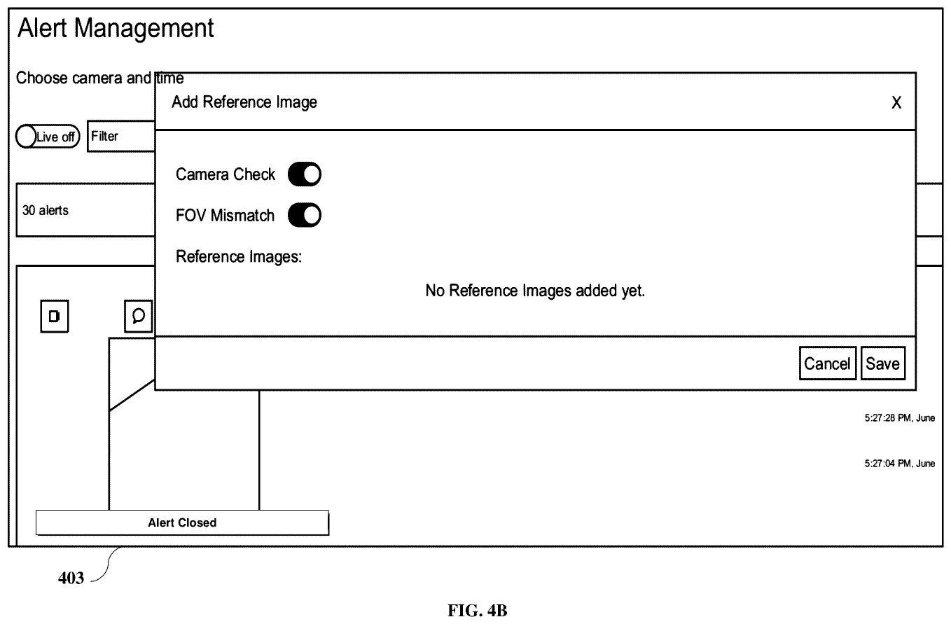

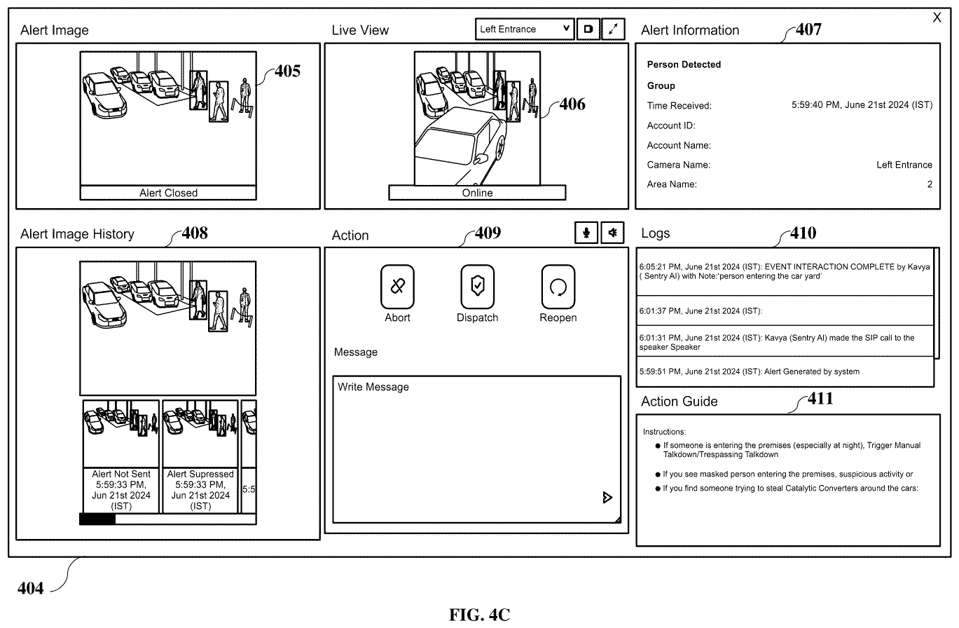

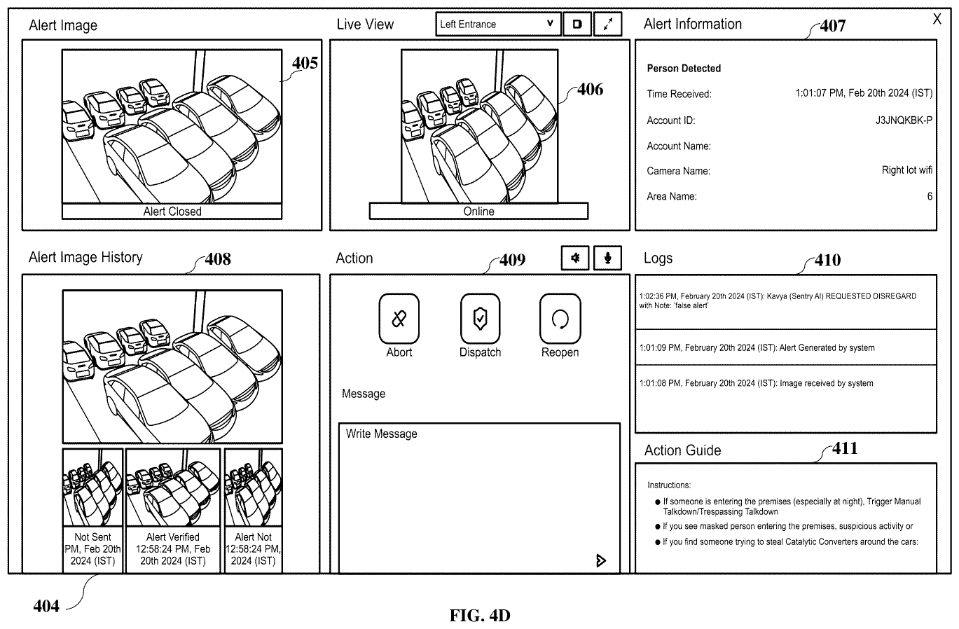

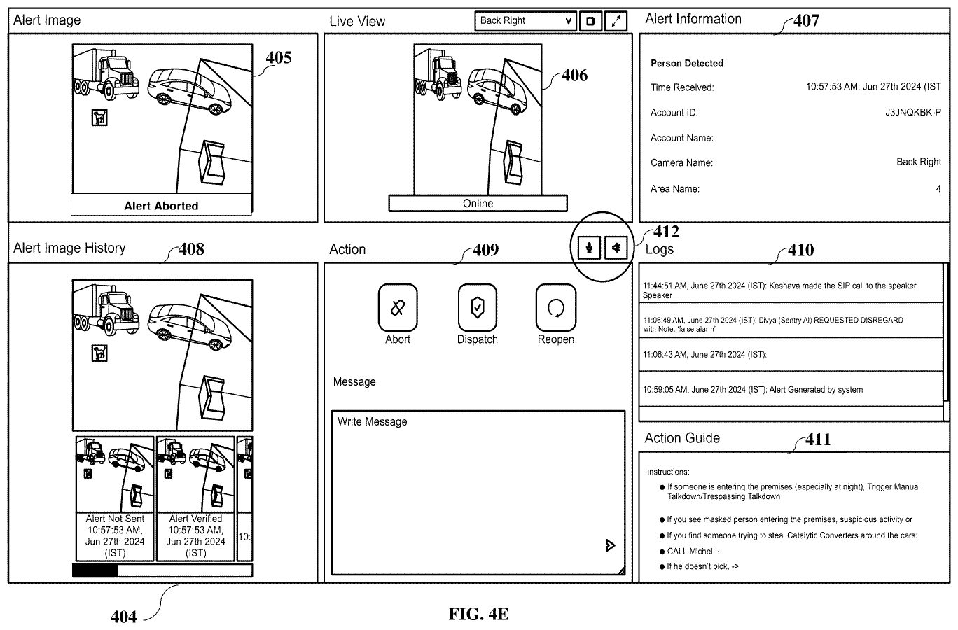

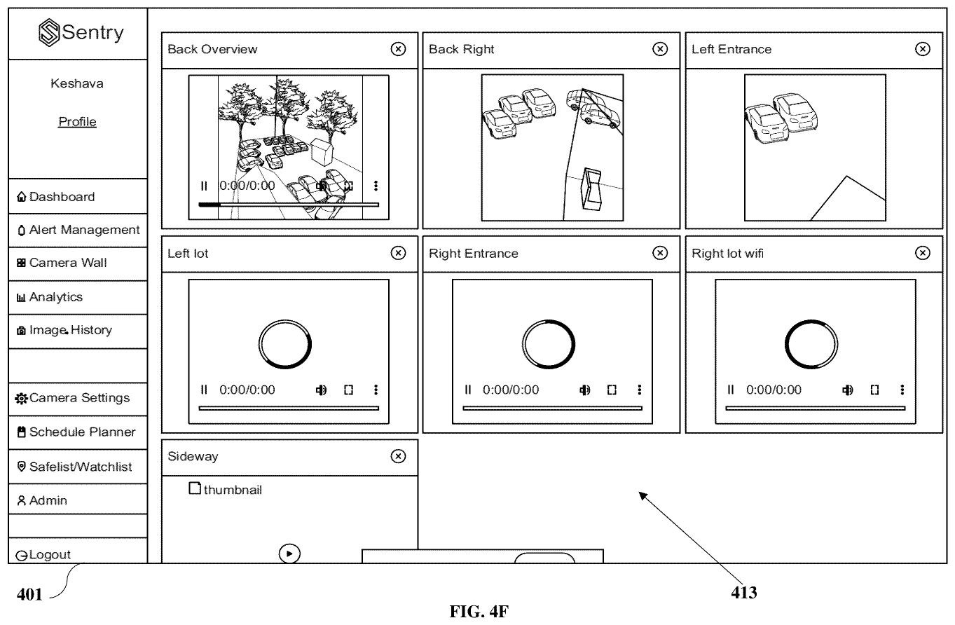

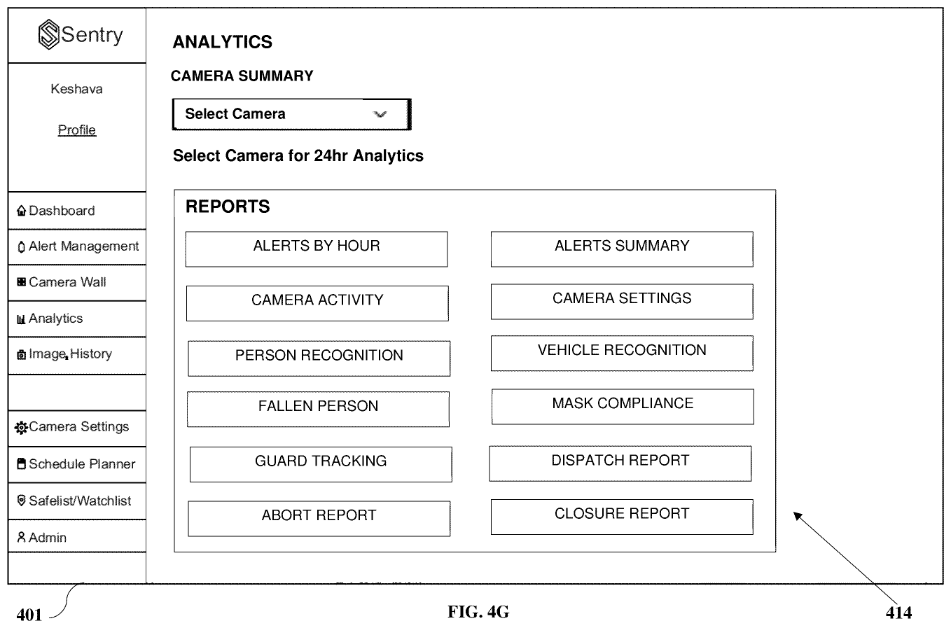

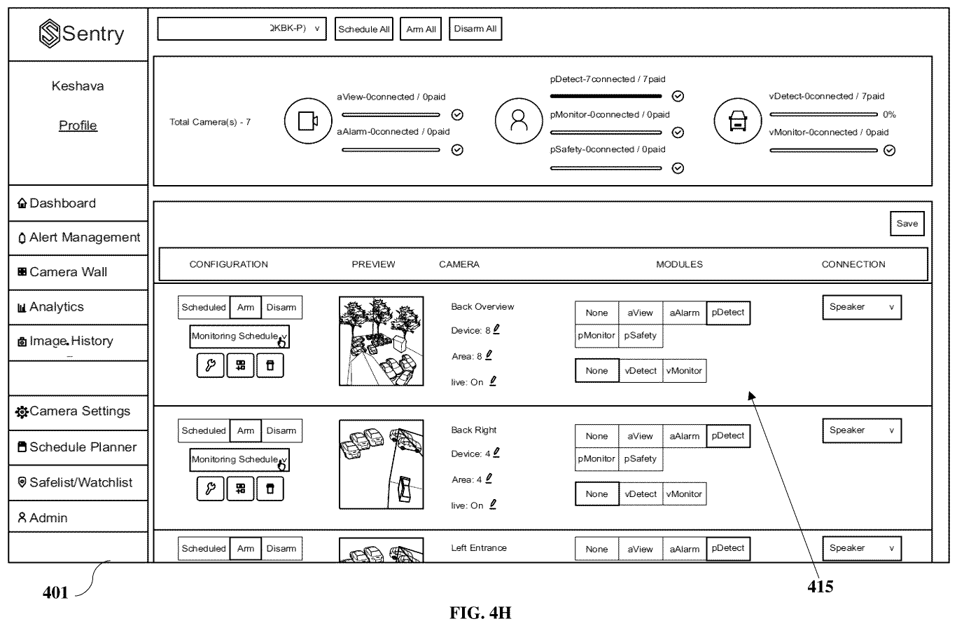

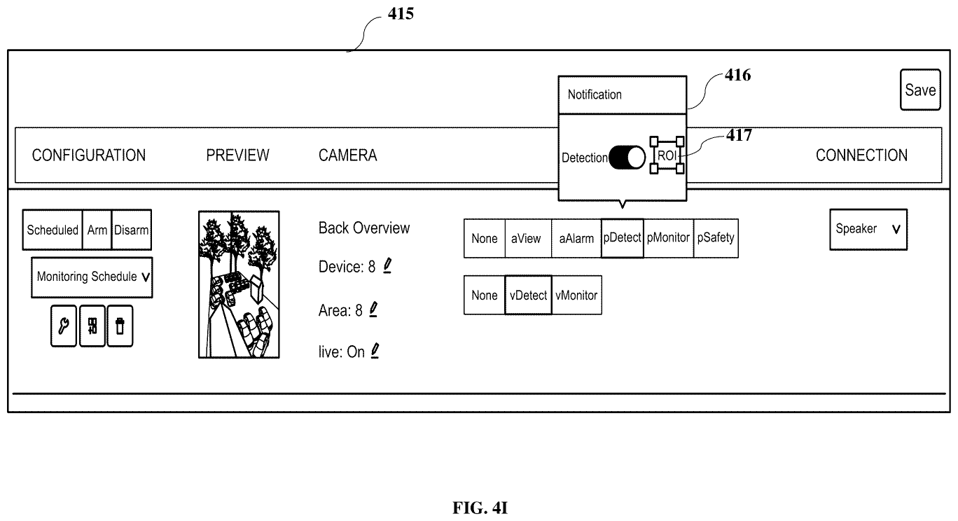

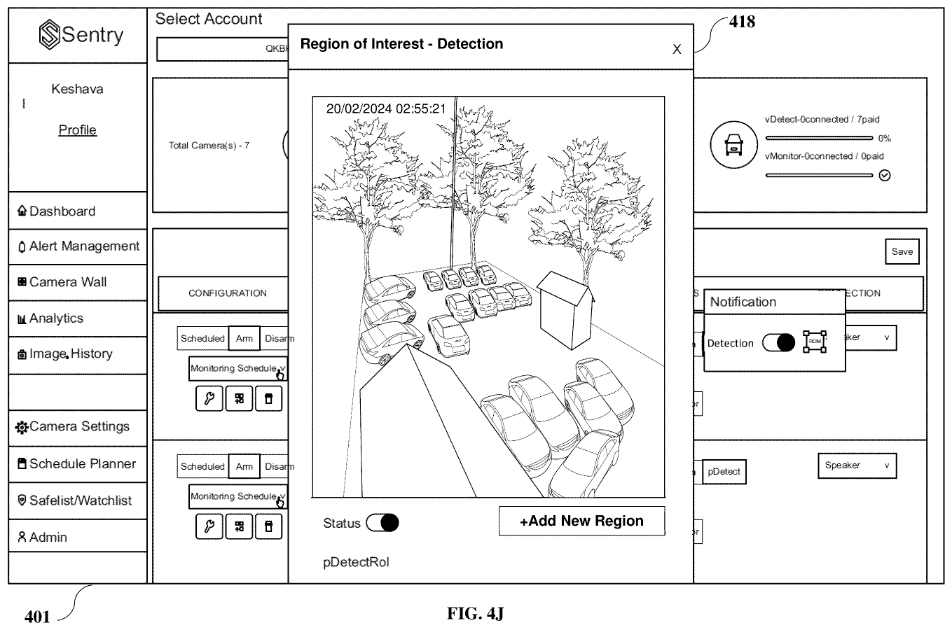

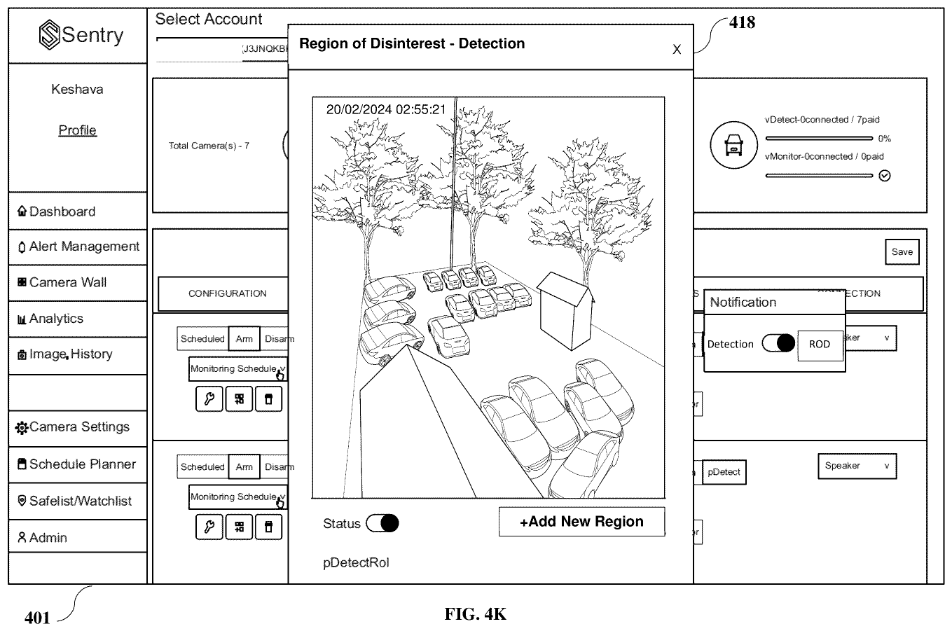

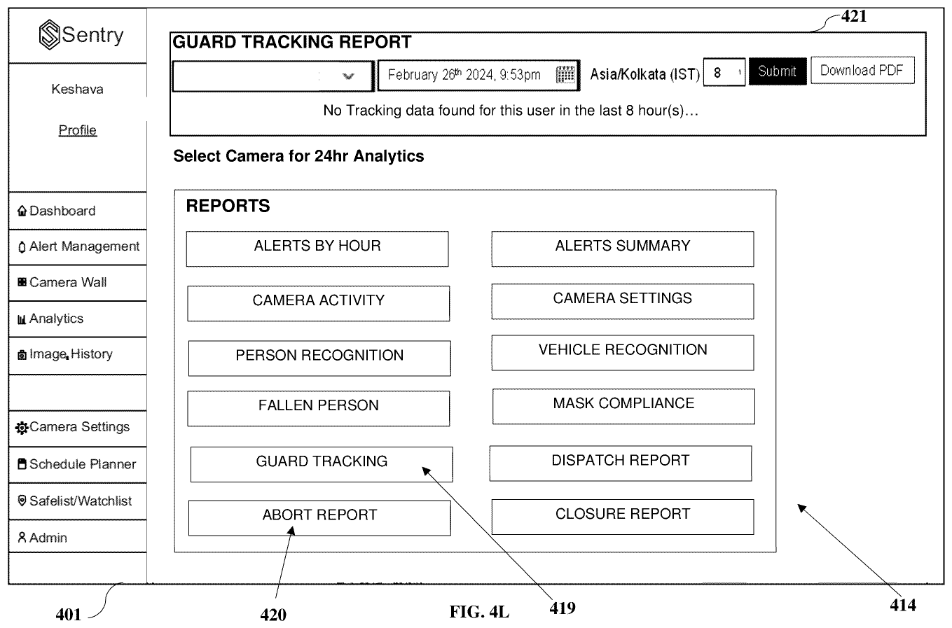

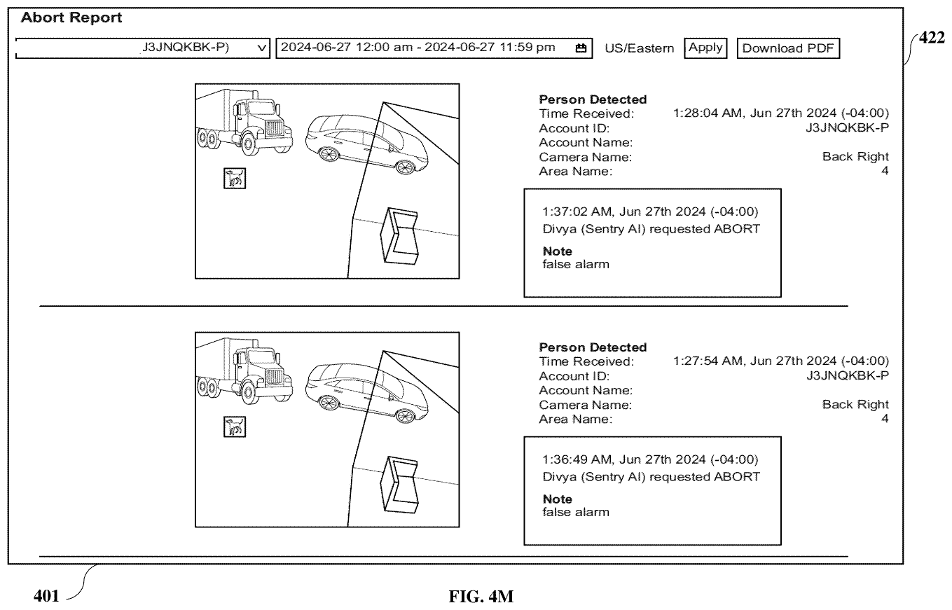

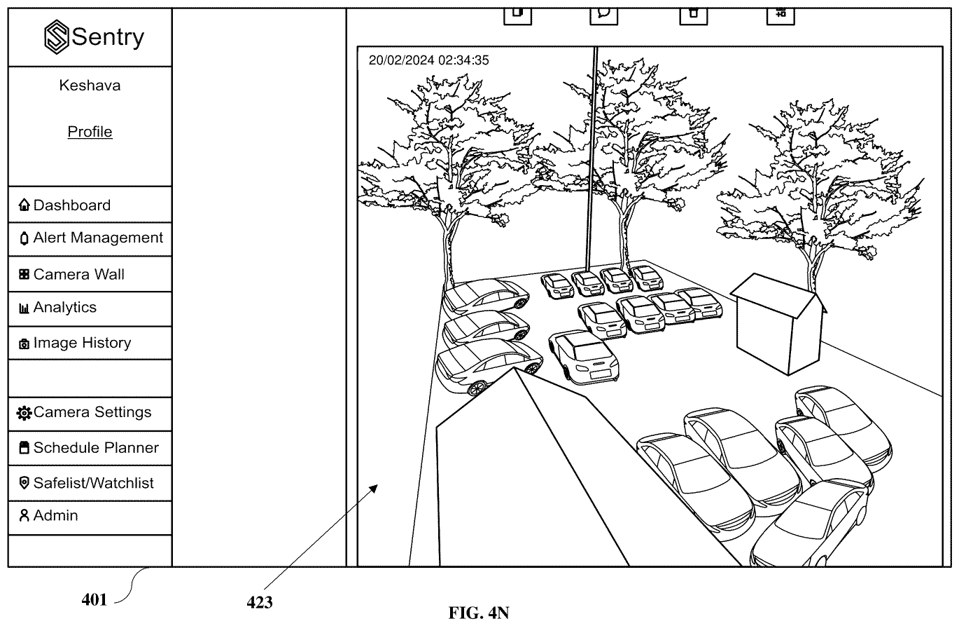

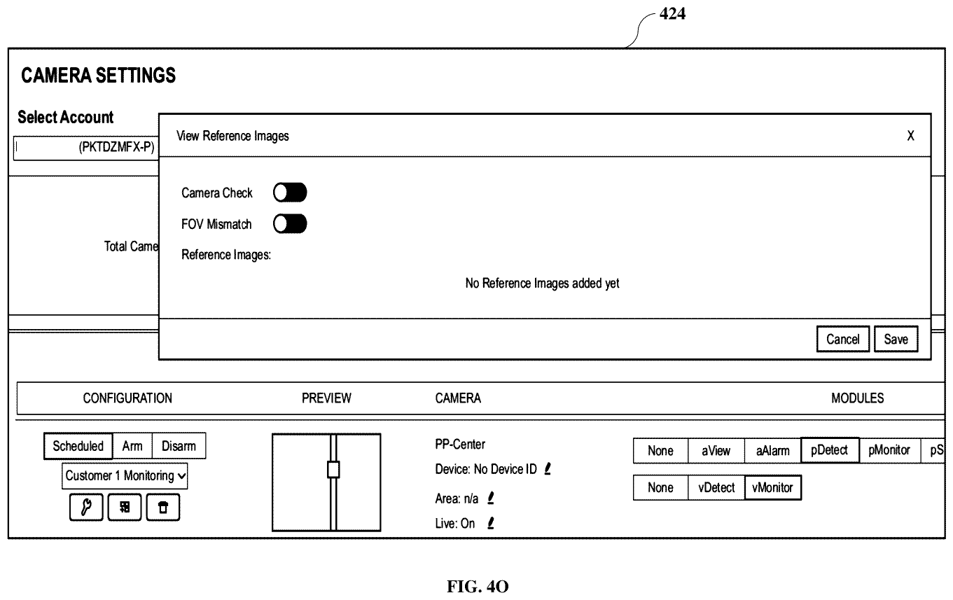

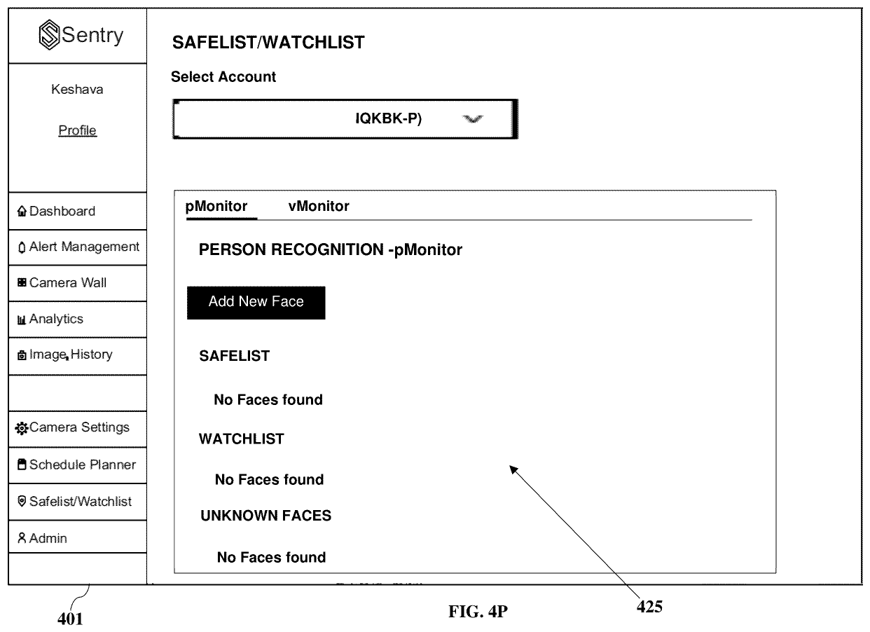

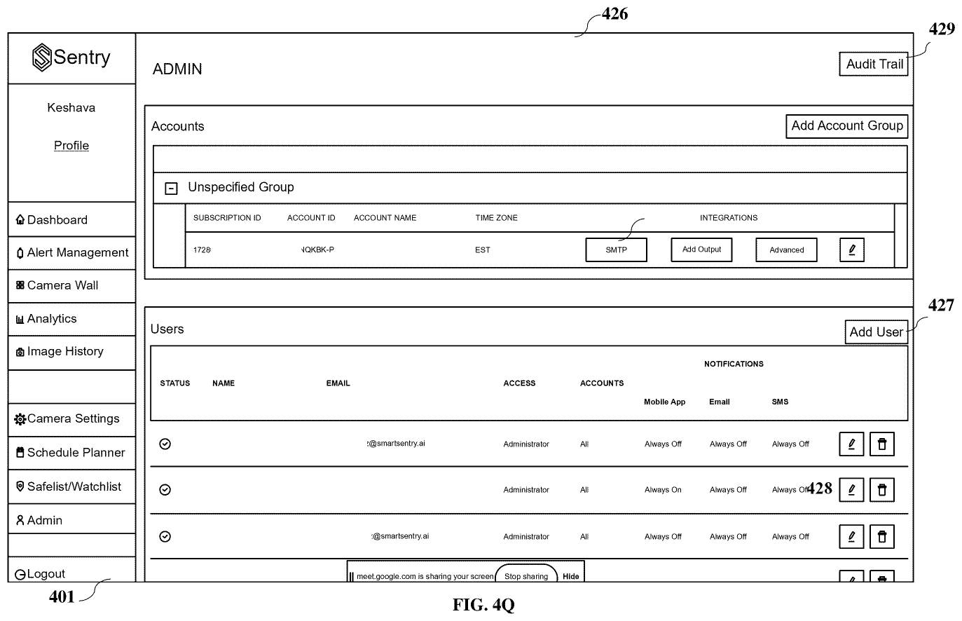

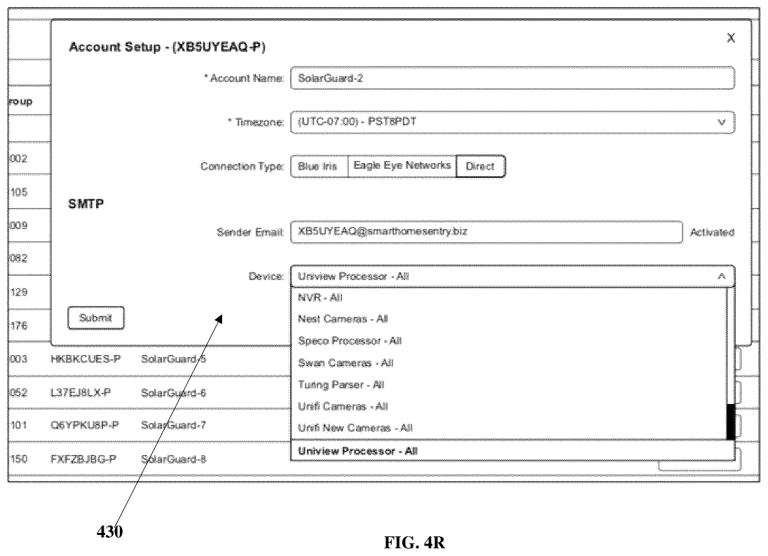

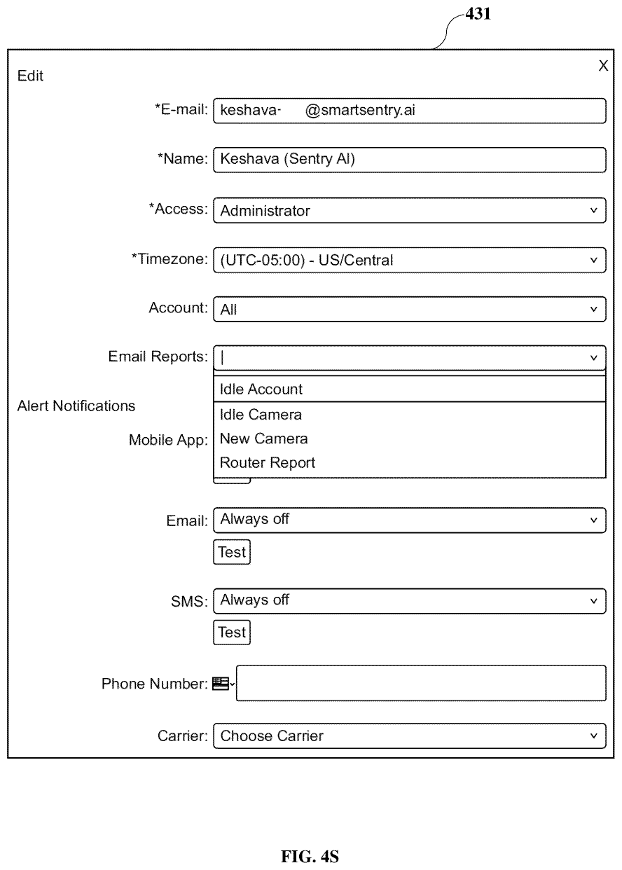

To improve the precision of the detections performed by the image processing engine 102 and enable continuous improvement of module performance through active learning of the AI modules 104, for example, machine learning modules 104, the IUI surveillance system 100 incorporates a user review in the detection process, via the IUI 107, to verify the validity of the generated resultant data. In the IUI surveillance system 100 disclosed herein, the control unit 106 is operably coupled to the IUI 107, whereby a user can review and verify the generated resultant data and influence operation of the control unit 106. In an example, the IUI 107 receives inputs from the user that allows the user to further refine detections and reduce or eliminate false positives generated by the machine learning algorithms, thereby ensuring only verified events trigger alerts. In an embodiment, the IUI 107 renders comprehensive history and analytics views, comprehensive setup and configuration views, and a guard monitoring portal as disclosed in the descriptions of FIGS. 4A-4R.

The intelligent user interface (IUI) 107 is in operable communication with the control unit 106. In an embodiment, the IUI 107 is configured to accept a user input comprising tuning parameters for the image capture devices 101, the identification of the regions of interest, the identification of the regions of disinterest, the determination of multiple interest elements, and the AI modules 104. In other embodiments, various parameters of each image capture device 101 are controllable. The IUI 107 allows tuning of the image capture devices 101 for maximum effectiveness. In an example, the IUI 107 allows a user to set focus, frame rate, shutter speed, aperture, contrast, Wide Dynamic Range (WDR), brightness, etc., of each image capture device 101 remotely. In an embodiment, the IUI 107 provides settings at each image capture device level to provide users with finer controls on how the images from the image capture device 101 are processed and what alerts are generated. Each image capture device 101 is treated as an image stream and can be configured via the IUI 107.

In various embodiments, parameters of motion detection performed by the motion filtering and preprocessing module 103 are also controllable. In an example, the intelligent user interface (IUI) 107 allows a user to configure settings to allow the motion filtering and preprocessing module 103 to differentiate between significant motion and irrelevant motion, thereby reducing the number of image frames analyzed by the motion filtering and preprocessing module 103. In an embodiment, the IUI 107 allows a user to tune parameters for the machine learning algorithms and other AI modules 104 in the cloud to improve detection. For example, the IUI 107 allows the user to select appropriate Convolutional Neural Network (CNN) and its parameters to improve detection. Furthermore, the selection of the AI modules 104 applied on each image capture device 101 represents different features comprising, for example, person detection, vehicle detection, vehicle license plate registration recognition, person recognition, community safety features, etc. The IUI 107 allows the features applied on the image capture devices 101 to be changed any time. The image processing engine 102 checks against the applied features every time an image is processed and performs the appropriate processing of the image.

In an embodiment, the IUI 107 is configured to accept false positives identified by the user based on the selectively rendered resultant data. The IUI 107 accepts a refined selectively rendered resultant data from the user that allows the users to refine the selectively rendered resultant data to further refine detections and eliminate false positives generated by AI modules 104, thereby ensuring only verified events trigger alerts. In a further embodiment, the IUI 107 is configured to display alerts to the user and receive further commands and annotations from the user to reduce false positives. In various embodiments, the IUI 107 is configured to receive response actions on the displayed alerts. In another embodiment, if the user marks the resultant data generated by an artificial intelligence-based detection or machine learning algorithms as a false positive, this feedback/information is used to update the artificial intelligence (AI) modules 104 in subsequent iterations and to find alternative solutions for reducing false alarms, without increasing missed detection rates.

In an embodiment, the intelligent user interface (IUI) 107 allows the control unit 106 to extract the tuning parameters and the refined false positives from the IUI 107 and communicate it to the image processing engine 102 for updating the AI modules 104 and the resultant data. The image processing engine 102 communicates the updated resultant data comprising, for example, verified detections, trigger actionable alerts to the control unit 106. In an example, the control unit 106 transmits the actionable alerts to boots-on-the-ground, security personnel. These actionable alerts provide information, such as the nature of an event, detection of a person and/or a vehicle, and their locations within the surveillance area. In an embodiment, the control unit 106 is configured to capture user settings and user input from the IUI 107. In another embodiment, the control unit 106 routes various settings configured on the IUI 107 to the image capture devices 101, the motion filtering and preprocessing module 103, the pipeline of AI modules 104, and the post-processing module 105. In another embodiment, the control unit 106 transmits device settings and responses to the alerting devices 108, for example, speakers, lights, etc., and transmits the actionable alerts to the external response system 109.

The control unit 106 is further configured to execute response actions based on the updated resultant data. One of the response actions comprises, for example, rendering alert notifications in multiple modes via alerting devices 108. The modes comprise, for example, a text mode, an electronic mail (email) mode, an audio mode, a voice mode, a light mode, siren mode, an AI-generated mode, a real-time notification mode, a media playback mode, a push-to-talk mode, etc. The alerting devices 108 comprise, for example, speakers such as Internet Protocol (IP) speakers, lights, computing devices such as tablets, smartphones, personal digital assistants, etc. In an example, one or more speakers and lights may be used for deterring an intruder by playing user or AI-generated, live or pre-recorded, warning messages or siren-type sounds, relaying a voice of a user, or turning on static or flashing lights. In an embodiment, the alerting devices 108, for example, the speakers and the lights, are installed on a site of the surveillance area being monitored by the image capture devices 101. In an embodiment, the speakers utilize enhanced intelligence from a server on the cloud instead of onboard intelligence. The enhanced intelligence allows the speakers to be used, for example, for automatic talkdown, manual playback of pre-recorded messages, push-to-talk, etc., as disclosed in the description of FIG. 4H. In an embodiment, the control unit 106 is configured to export configuration data and the generated resultant data into one of many standard formats, for example, a Comma-Separated Values (CSV) format, a Portable Document Format (PDF) for further viewing and analytics.

In an embodiment, the intelligent user interface (IUI) 107 is configured to generate and render a comprehensive view of the image stream on a display unit, wherein the rendered comprehensive view of the image stream comprising real-time image frames with highlighted interest elements, and an alert history extracted from the resultant data. The IUI comprises multiple portals or applications serving an administrator, a remote monitoring agent, the user, and on-premises guard. This comprehensive view allows the users to maintain situational awareness and visualize overall activity within the surveillance area, including history comprising previous images from each image capture device 101.

In an embodiment, the IUI 107 comprises multiple IUI elements. In an embodiment, a first IUI element from among the multiple IUI elements is configured to allow a user to define regions of interest and regions of disinterest within the surveillance area to reduce the false positives. In an embodiment, a second IUI element from among the multiple IUI elements is configured to allow the user to annotate and correct the regions of interest and disinterest.

In an embodiment, the control unit 106 is further configured to transmit selected actionable alerts associated with the updated resultant data to the external response system 109 for deterrence of intrusion. The selected actionable alerts comprise alerts, signals, and audio messages. In an embodiment, the external response system 109 comprises one or more of audio speakers, alarms, sirens, lights, security personnel, for example, of a boots-on-the-ground security agency. In another embodiment, the external response system 109 comprises remote monitoring agents assigned to remotely monitor the image capture devices 101, the selected actionable alerts, and at least part of the updated resultant data for executing the response actions. In an example, the control unit 106 transmit alarms to users via multiple external response systems 109. These external response systems 109 comprise, for example, a mobile application employed by the IUI surveillance system 100, short message service (SMS) messaging systems for transmitting text messages, email systems, custom integrations, etc. The integration of the IUI surveillance system 100 with these external response systems 109 is configurable and exposed to the users for setup during onboarding. The IUI surveillance system 100 provides administrators with a holistic view of the configured external response systems 109 and allows changes to the configuration based on user preferences and availability. In an embodiment, the response actions are configured to follow a time schedule to alert the users only during specific time slots, for example, during off-hours. In various embodiments, the IUI surveillance system 100 monitors connections to the external response systems 109 and automatically generates an alert in case of any failure in the external response systems 109.

Consider an example implementation of the IUI surveillance system 100 as a video surveillance system 100. In an embodiment, the video surveillance system 100 comprises multiple video cameras, a motion filtering and preprocessing module 103, an AI modules 104 comprising a machine learning module, an intelligent user interface, and an alerting system. The video cameras are configured to capture video frames from a surveillance site. The motion filtering and preprocessing module 103 processes the captured video frames to identify video frames containing motion. In an embodiment, the motion filtering and preprocessing module 103 employs algorithms to differentiate between significant motion and irrelevant motion, reducing the number of video frames analyzed by the machine learning module 104.

The machine learning module 104 is trained to analyze the captured video frames identified by the motion filtering and preprocessing module 103, and detect and classify objects within the captured video frames, for example, as persons or vehicles. In an embodiment, the machine learning module 104 comprises a neural network trained on a dataset of video frames labeled with objects classified, for example, as persons and vehicles. The intelligent user interface (IUI) 107, allows an IUI surveillance system (IUISS) user to review the detected objects, manually reduce false positives, and set various detection parameters. In an embodiment, the IUI 107 comprises tools configured to allow the IUISS user to define exclusion zones within the surveillance area to reduce false positives. In a further embodiment, the IUI 107 further comprises tools configured to allow the IUISS user to annotate and correct the classification of objects, thereby further training the machine learning module 104. In an embodiment, the machine learning module 104 continuously updates its object detection models based on feedback from the IUISS user via the IUI 107.

The alerting system dispatches notifications to security personnel based on alerts generated by the machine learning module 104 and verified by the IUISS user. In an embodiment, the alerting system provides options for different modes of notification, such as email, text message, or direct communication to a security operations center. In an embodiment, the IUI 107 provides a comprehensive view of all the video cameras 101a, 101b, being monitored and the history of the verified alerts. The comprehensive view provided by the IUI 107 comprises, for example, real-time video feeds from all cameras 101a, 101b, with highlighted video frames containing detected objects. In an embodiment, the video surveillance system 100 further comprises a guard monitoring portal configured to monitor locations of the guards and their responses to the verified alerts. In an embodiment, the alerting system is configured to prioritize alerts based on the type and number of objects detected in the video frames. In an embodiment, the IUI surveillance system 100 is configured to store the video frames and associated metadata, allowing for later review and analysis. The IUI surveillance system 100 integrates with other security systems, for example, access control or alarm systems, to provide a coordinated response to detected events.

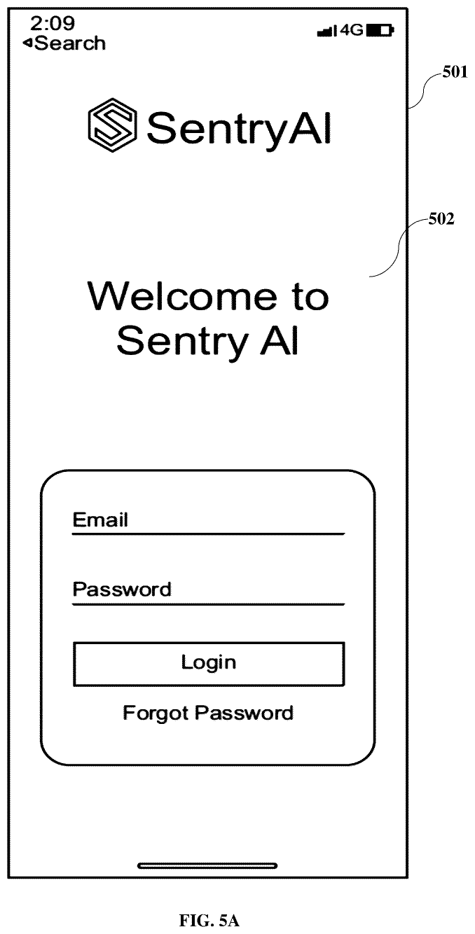

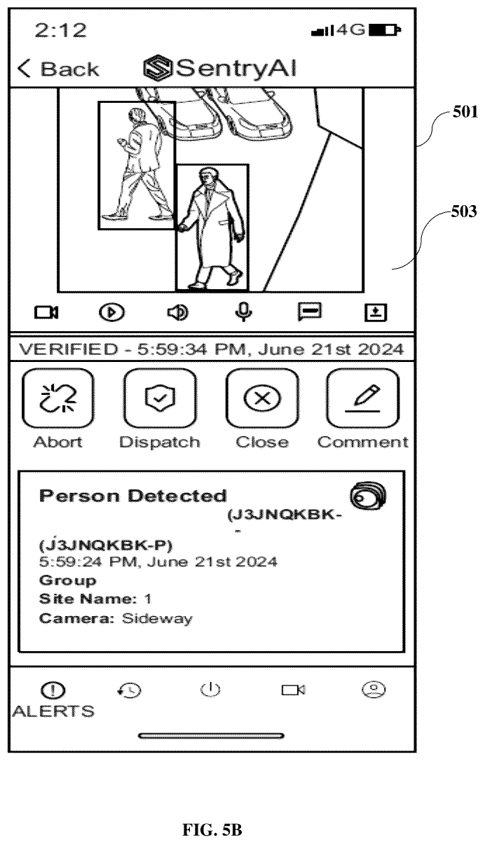

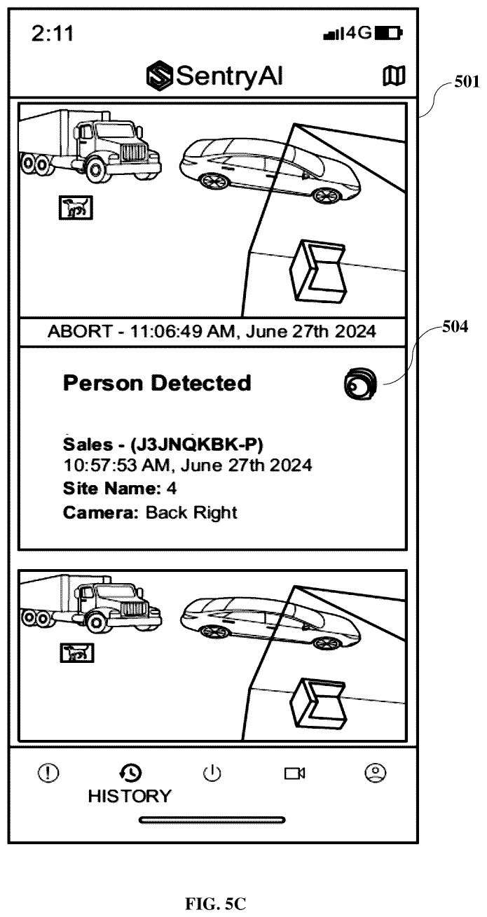

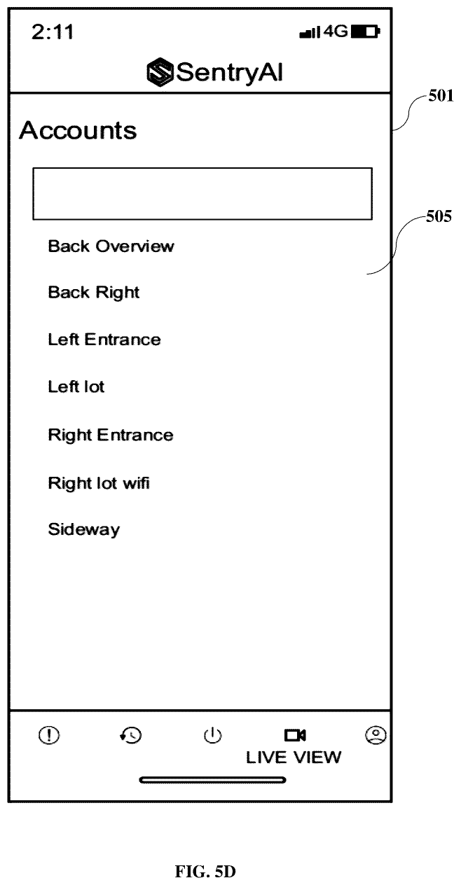

In an embodiment, the IUI surveillance system 100 further comprises a desktop-based application deployable on a user device, for example, a desktop computer, a personal computer, a laptop, etc. The desktop-based application executes multiple functionalities of the IUI surveillance system 100. In another embodiment, the IUI surveillance system 100 further comprises a mobile application (not shown) deployable on a user device for displaying the resultant data and receiving user input via the IUI 107 as disclosed in the description of FIGS. 5A-5D. In an embodiment, the mobile application is configured to monitor the location and the response actions of the security personnel associated with the external response system 109. The mobile application executes many of the functionalities of the desktop-based application. By incorporating a pipeline of image processing and AI modules 104 including machine learning modules with an IUI feature, the IUI surveillance system 100 with its IUI 107 substantially reduces false positives and optimizes the alerting process, thereby improving the overall reliability of surveillance operations.

In an embodiment, the IUI surveillance system 100 comprises solar guard trailers configured as mobile monitoring units that are movable to different locations on a need basis. Unlike conventionally installed cameras 101a, 101b, the solar guard trailers are solar-powered and set up with hardware equipment that is needed to monitor and communicate with the IUI surveillance system 100. In an embodiment, each solar guard trailer comprises a power monitor, a network video recorder, a predetermined number of cameras 101a, 101b, for example, up to or more than four cameras, and a few access protection devices. In an embodiment, each solar guard trailer further comprises an Nth generation wireless router, for example, a 4G wireless router, a 5G wireless router, a 6G wireless router, etc., configured to establish a connection with a cloud-based system implemented by the IUI surveillance system 100. The cameras 101a, 101b are installed on a rooftop of each solar guard trailer, for example, about 30 feet high. These solar guard trailers can be moved and set up in open spaces with minimal effort and do not require any permanent physical installation of surveillance equipment.

The IUI surveillance system 100 allows prevention of threats with automatic lights, automatic talkdown, etc., via the alerting devices 108. Moreover, the control unit 106 of the IUI surveillance system 100 transmits real-time notifications of suspicious activity to monitoring agents who can call security personnel, for example, authorities, guards, or users. The IUI 107 provides flexible search features both at an activity level and at a clip level. Furthermore, the IUI surveillance system 100 performs collaborative alert management, where AI, an end-user, a monitoring agent, and a guard can collaborate with each other and where all actions and communications are logged including guard location and movement.

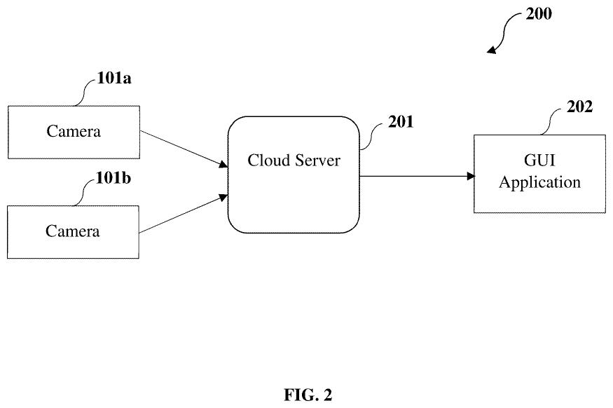

FIG. 2 illustrates a block diagram of an embodiment of a system 200 for securing the intelligent user interface (IUI) surveillance system 100 shown in FIG. 1. An application-level network protocol, for example, a Real-Time Streaming Protocol (RTSP), is typically utilized for multiplexing and packetizing multimedia transport streams such as video streams from image capture devices such as cameras and Network Video Recorders (NVRs). Conventional web browsers may not be able to play the RTSP video streams and may need specialized media player applications, for example, VideoLAN Client (VLC) applications, to play the RTSP video streams. Moreover, an RTSP Uniform Resource Locator (URL) to each RTSP video stream utilizes a specific format for transmission including, for example, a username and a password, for authentication. To preclude a risk of compromising authentication credentials when the RTSP URL is exposed to end-users and to support the playing of live video streams on web browsers, in an embodiment, the IUI surveillance system 100 proxies the video streams through a cloud server, for example, a cloud server 201.

In an embodiment of the system 200 disclosed herein, the image capture devices, for example, the cameras 101a and 101b, of the IUI surveillance system 100 are configured to operably communicate with the cloud server 201. In other embodiments, the cameras 101a and 101b communicate with the cloud server 201 via a network, for example, the Internet. Furthermore, the cloud server 201 is configured to communicate with a Graphical User Interface (GUI) application 202 deployable on a user device, as shown in FIG. 2. The cloud server 201 communicates with the GUI application 202 on the user device via a network, for example, the Internet. The GUI application 202 renders the IUI 107 of the IUI surveillance system 100 on the user device. In an embodiment, an image stream such as a camera live stream or a video stream captured by the cameras 101a and 101b is securely proxied through the cloud server 201, and converted into an enhanced display format for display on the IUI 107 via the GUI application 202. The cloud server 201 converts the image stream into an enhanced display format to support the playing of live video streams on web browsers.

In an embodiment, the control unit 106 of the IUI surveillance system 100 illustrated in FIG. 1, terminates the video streams, for example, RTSP video streams, received from the cameras 101a and 101b at the cloud server 201. On receiving the RTSP video streams, the cloud server 201 converts the RTSP video streams into a web-friendly, display format, for example, a Hypertext Transfer Protocol (HTTP) Live Streaming (HLS) format. The cloud server 201 streams the video in the enhanced display format to a frontend GUI, for example, the IUI 107 of the IUI surveillance system 100. By proxying the RTSP video streams, an end-user, for example, a monitoring agent, is unaware of the credentials of the RTSP video streams. Furthermore, specialized media player applications are not required for viewing the RTSP video streams that are converted to the enhanced display format.

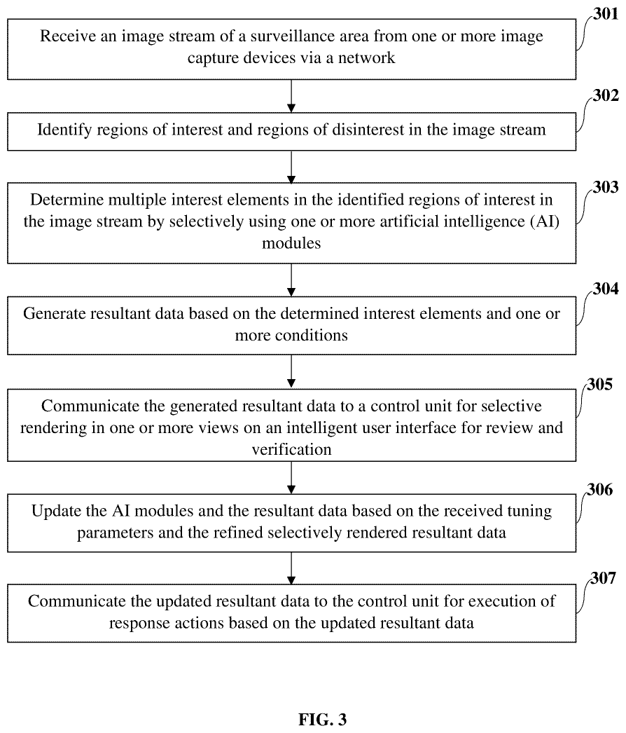

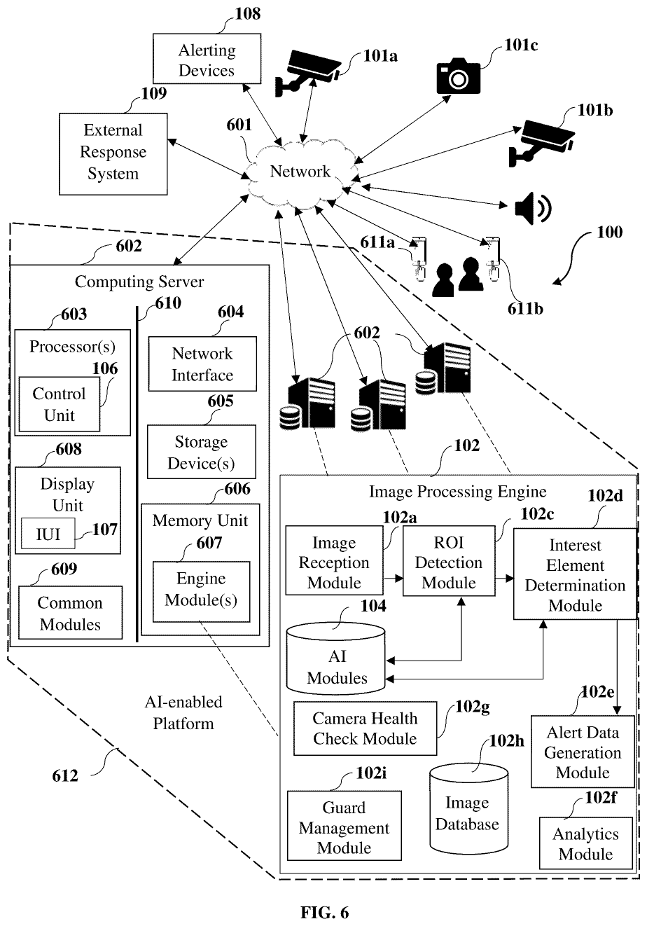

FIG. 3 illustrates a flowchart of an embodiment of a method for facilitating intelligent user interface (IUI) surveillance. In an embodiment, the method disclosed herein employs the image processing engine 102 illustrated in FIG. 2 for facilitating IUI surveillance. In the method disclosed herein, the motion filtering and pre-processing module 103 of the image processing engine 102 receives 301 an image stream of a surveillance area from one or more image capture devices via a network 601, as shown in FIG. 6. The image processing engine 102 identifies 302 regions of interest and regions of disinterest in the image stream using the motion filtering and pre-processing module as disclosed in the description of FIG. 1. The regions of interest comprise regions of significant motion, and regions of disinterest comprise regions outside physical boundaries of the surveillance area. The motion filtering and pre-processing module 103 of the image processing engine 102 further identifies the regions of significant motion to focus analysis, and further reduce false positives in motion detected by the onboard processing performed by the image capture devices. The regions of interest and the regions of disinterest are one or more of user-specified or auto-suggested by an artificial intelligence (AI) system comprising neural networks that recognize the regions of interest and the regions of disinterest of the surveillance area. The image processing engine 102 removes objects detected outside the identified region of interest or within the regions of disinterest. The image processing engine 102 determines 303 multiple interest elements in the identified regions of interest in the image stream by selectively using one or more artificial intelligence (AI) modules 104 in the image processing engine as disclosed in the description of FIG. 1. The multiple interest elements in the identified regions of interest in the image stream comprises faces, humans, animals, vehicles, objects, markers, and events. The image capture device captures and transmits a burst of image frames to the motion filtering and preprocessing module upon detecting motion, and wherein the motion filtering and preprocessing module processes the received burst of frames using 2D Fourier transforms to filter out spurious motion alerts.

The motion filtering and pre-processing module 103 of the image processing engine 102 employs multiple motion detection techniques comprising one or more of utilization of two-dimensional (2-D) Fourier transforms or other transforms, histogram equalization, shape analysis of areas of significant pixel value difference between image frames, inter-frame pixel value differencing, and region-wise aggregation of differences, for refined motion detection. The motion filtering and pre-processing module 103 further performs image frame enhancement comprising one or more of noise reduction, contrast enhancement, region-adaptive contrast enhancement, and brightness adaptation to improve image quality for improving performance of the artificial intelligence (AI) modules. The motion filtering and pre-processing module 103 further enhances motion detection by using information from three consecutive image frames and processing the 2-D Fourier transforms for robust frame differencing that rejects false alarms in frame differences due to rain, snow, and changing light. The frames filtered for motion are input into a convolutional neural network or transformer network of the AI Module of the image processing engine for detection of the humans and the vehicles. If the humans or vehicles are detected, the frames filtered for motion are further input into a video analysis neural network of the artificial intelligence module of the image processing engine for event and behavior detection or an event or behavior is detected based on hard-coded rules applied to detection of objects, location of objects, their motion in time, and confidence scores of the detected objects to detect events of interest.

The image processing engine 102 generates 304 resultant data, using AI modules, based on the determined interest elements and one or more conditions. The conditions comprise configurable thresholds associated with overlaps between multiple interest elements and the identified regions of interest, location of the interest elements, size of the interest elements, type of the interest elements, number of the interest elements, time period of detections of the interest elements, configurable schedules, field of view changes, and preferences of the user. The resultant data comprises the identified regions of interest, the identified regions of disinterest, the determined interest elements, actionable alerts, the tuning parameters, alert history, alert response history, alert response standard operating procedures, alert response statistics, and information about behavior of an external response system. The image processing engine 102 uses a post-processing unit to communicate 305 the generated resultant data to the control unit 106 illustrated in FIG. 1, for selective rendering in one or more views on the IUI 107 for review and verification. The IUI 107 is configured to receive tuning parameters from a user for the image capture devices, the identification of the regions of interest and regions of disinterest, the determination of the interest elements, and the AI modules 104. The IUI 107 is further configured to receive, from the user, by the control unit, an identification of false positives, in response to the selectively rendered resultant data. The IUI 107 is further configured to receive, from the user, by the control unit, a refined selectively rendered resultant data, for eliminating the false positives generated by the AI modules. The IUI 107 is further configured to communicate the received tuning parameters and the refined selectively rendered resultant data to the image processing engine 102 via the control unit 106 illustrated in FIG. 1. The image processing engine 102 updates 306 the AI modules 104 and the resultant data based on the received tuning parameters and the refined selectively rendered resultant data. The image processing engine 102 communicates 307 the updated resultant data to the control unit 106. The control unit 106 is configured to execute response actions based on the updated resultant data.

The control unit is configured to transmit selected actionable alerts associated with the updated resultant data to an external response system for deterrence of intrusion. The selected actionable alerts comprise alerts, signals, and audio messages. The external response system comprises one or more of audio speakers, alarms, sirens, lights, security personnel and remote monitoring agents assigned to remotely monitor the one or more image capture devices, the selected actionable alerts, and at least part of the updated resultant data for executing the response actions.

Consider an example of the operation of a video surveillance system 100 for IUI surveillance. The video surveillance system 100 receives video data from multiple cameras 101a, 101b, and analyzes the video data using machine learning algorithms to identify frames containing motion. The video surveillance system 100 further analyzes the motion-containing frames using machine learning to detect the presence of interest elements, for example, persons and vehicles. The video surveillance system 100 renders information about the detections to an IUISS user via the IUI 107 for review and verification. Upon receiving verification of a detection from the IUISS user, the video surveillance system 100 generates an alert containing information about the verified detection, including the nature of the event, for example, person, vehicle, etc., and its location within the surveillance area. The video surveillance system 100 transmits the generated alert to designated personnel.

Consider another example of the operation of a video surveillance system 100 for IUI surveillance. The video surveillance system 100 receives a burst of images or frames, i.e., video data, from one or more cameras 101a, 101b, where the motion is detected. The time window for application of the AI module 104 that has been set by the user is compared to the time stamp of the burst of images received, and only those bursts that fall in the set time window are processed further. The IUI surveillance computes 2-D Fourier transform of the received burst of images. The IUI surveillance computes the change in the total power (squared magnitude) of the 2-D Fourier transform across a moving window of three consecutive frames. If the power changes more than a pre-specified threshold, then the burst of frames is declared as having significant motion. The IUI surveillance applies a convolutional neural network, such as YOLOv11, on the burst of images with significant motion and for each frame bounding box coordinates, confidence of each bounding box being a person or a vehicle is generated and compared to the respective thresholds set for the camera 101a, 101b, and class of object such as person or vehicle. The IUI compares the coordinates of the bounding boxes with high confidence against the regions of interest and regions of disinterest set by the user. Only those bounding boxes that fall in the region of interest and do not fall in the region of disinterest are further processed by the IUI. If the confidence of the object detection is above the said predefined threshold, then an alert is generated for the user in the loop, or the event detection module. The user in the loop, or the event detection module decides if the detection of person or vehicle was correct, and if the detection is that of an intruder. In case the detection was a false positive, the alert is “aborted.” In case the detection was a true positive, but the person or the vehicle did not have a malicious intent, then the alert is “closed.” If the person or the vehicle is suspected of malicious intent, such as intrusion, then the alert is “dispatched”. The user or AI agent refers to an “action guide” in order to decide the specific further course of action for “dispatched” events. The action guide includes the priority order of specific actions, such as “talk to the intruder with the aim of deterring them into leaving the scene”, followed by “call the owner at number X if the intruder is not deterred”, followed by “call the police at number Y if the owner does not pick up the call”.

FIGS. 4A-4S illustrate screenshots of an intelligent user interface (IUI) 401 configured for rendering a comprehensive view of an image stream captured by one or more image capture devices 101 shown in FIG. 1, and facilitating IUI surveillance. The IUI surveillance system 100 illustrated in FIG. 1, provides a user-friendly Graphical User Interface (GUI), herein referred to as the IUI 401, for example, for account creation, account management, camera association with an account, speaker and light association, camera and speaker settings, recording messages to be played at speakers, preprocessing settings, artificial intelligence (AI) settings, and post-processing settings. The IUI surveillance system 100 also provides the IUI 401, for example, for live view monitoring, viewing history, live alert monitoring, alert history viewing, alert response standard operating procedure (SOP) editing, alert response SOP viewing, alert response viewing, alert response history viewing, alert response analytics, external response settings, external response monitoring, external response analytics, etc.

In an embodiment, the IUI surveillance system 100 allows an IUI surveillance system (IUISS) user operating the IUI 401 to customize settings associated with each camera 101a, 101b, speaker, light, and account. In various embodiments, through operations with the IUI 401, the IUI surveillance system 100 allows reduction of errors, an increase in the timeliness of responses, and analysis of system behavior. Furthermore, the IUI 401 collects data for ongoing improvement of the preprocessing, AI, and post-processing components of the IUI surveillance system 100. For example, the IUI 401 allows the IUISS user to configure various settings of an account, the image capture devices 101 such as cameras 101a, 101b, the motion filtering and preprocessing module 103, the pipeline of AI modules 104, the post-processing module 105, the alerting devices 108 such as speakers, lights, etc., and the external response system 109 illustrated in FIG. 1 to ensure desired system behavior. The IUISS user may check the IUI 401 for alerts generated by the post-processing module 105 and determine whether any of the alerts are false positives, not worthy of a response, or worth responding to. The control unit 106 of the IUI surveillance system 100 illustrated in FIG. 1 receives decisions made by the IUISS user as user inputs via the IUI 401. In an embodiment, the control unit 106 logs the user inputs and transmits the user inputs to the image processing engine 102 illustrated in FIG. 1 to update the AI modules 104 and the resultant data.

In an embodiment, the IUI 401 allows the IUISS user to abort and close the alerts. In another embodiment, the IUI 401 allows the IUISS user to respond to the alerts via the alerting devices 108 such as speakers by utilizing, for example, pre-recorded or live vocal messages, deterring sounds such as sirens and lights, etc., or by dispatching an alert to the external response system 109 illustrated in FIG. 1, after determining the validity of a threat in real-time. Security personnel, for example, a security guard or a police officer on the ground operate the external response system 109 for executing response actions to the alert. The control unit 106 records actions and inputs of the IUISS user via the IUI 401 in real time.

Furthermore, in an embodiment, the IUI 401 allows the IUISS user to view analytics of frame history and statistics, alert history and statistics, assessment history and statistics, response history and statistics, external response history and statistics, comprising, for example, number of frames with motion, number and types of alerts, number and types of assessment such as false positive, benign, worth responding, etc., number and type of responses such as speakers used, lights used, dispatched trigger to the external response system 109, time to respond, number and type of external response actions, time taken for external response actions, etc.

Furthermore, in an embodiment, the IUI 401 allows the IUISS user to manage schedules to be applied to the image capture devices 101 and one or more modules of the image processing engine 102. Schedules refer to timeslots, for example, on a daily and weekly basis, that are applied on the image capture devices 101 and users. In an example, the IUI 401 allows the IUISS user to schedule the image capture devices 101 to transmit images, clips, etc., to the image processing engine 102 only during a specific time slot. Similarly, notifications are configured to be transmitted to users within their timeslots. In an embodiment, the control unit 106 renders a schedule planning or management module on the IUI 401 to allow the IUISS user to create different named schedules that can be applied to the image capture devices 101 and the users.

FIGS. 4A-4C illustrate screenshots of the IUI 401 configured to allow management of alerts generated by the image processing engine 102. As illustrated in FIG. 4A, the IUI 401 displays a list of menu items, for example, a dashboard, an “Alert Management” item, a “Camera wall” item, an “Analytics” item, an “Image History” item, a “Camera settings” item, a schedule planner, a safelist/watchlist, and an “Admin” item, for selection by the IUISS user. When the IUISS user selects the “Alert Management” item on the IUI 401, the IUI 401 displays an alert display page 402 comprising multiple sets of image frames from various image capture devices 101, herein referred to as “cameras” 101a, 101b, for a particular user account. The alert display page 402 displays each set of image frames as a list with words or icons showing the nature of an interest element, for example, a person or a vehicle detected, an account name and an account identifier (ID), an area number, camera view, name of a person to be contacted, recent logs from that camera view, and controls to respond to the generated alerts.

The alert display page 402 lists alerts corresponding to an account, for example, latest first by default. When a user clicks an alert on the alert display page 402, the control unit 106 renders details about the alert comprising, for example, the previous or next images of the alerted image, alert logs, a live view, etc., which provides a context to users without any delay. The alert display page 402 also allows filtering and sorting of the generated alerts. An enlarged view of a portion of an alert management page 403 on the IUI 401 is illustrated in FIG. 4B. The alert management page 403 allows the IUISS user to add a reference image, configure settings to conduct a camera health check, identify a field-of-view (FOV) mismatch, etc. The alert management page 403 renders interface elements, for example, knobs, to activate or deactivate camera health check, and FOV mismatch settings. In an embodiment, the alert management page 403 provides alert management controls, for example, maximum number of alerts per a specific time interval, a minimum time interval between alerts, etc.

In an embodiment, the image processing engine 102 generates alerts when there is a change in a camera's field of view, for example, due to change in either orientation or tampering. The image processing engine 102 performs this alert generation by maintaining reference images and comparing the incoming image features against the reference images to determine where a static part of the camera view has changed. In an embodiment, the image processing engine 102 collects reference images automatically by sampling the images in fixed intervals. The image processing engine 102 collects the reference images during different times, for example, day, night, dusk, dawn, etc., to ensure there are enough samples from different lighting conditions. In another embodiment, the IUI 401 allows users to add images, for example, from an image history, to a reference image pool. The alert management page 403 or the camera settings page 424 illustrated in FIG. 4B and FIG. 4N, respectively, allows the users to add the reference images and view the added reference images.

When the IUISS user clicks on an alert displayed on the alert display page 402 illustrated in FIG. 4A, the IUI 401 displays an alert processing page 404 as illustrated in FIGS. 4C-4E. The alert processing page 404 comprises, for example, an alert image 405 with bounding boxes, a live view panel 406, an alert information panel 407, an alert image history panel 408, an action panel 409, a logs panel 410, and an action guide 411. The alert image 405 displays an enlarged view of an image associated with an alert and bounding boxes indicating interest elements, for example, persons, vehicles, etc., determined by the image processing engine 102. The control unit 106 executes live view monitoring via the live view panel 406 on the alert processing page 404. The live view panel 406 renders a live image stream from one or more cameras. For example, the live view panel 406 renders a live image stream from a camera that is associated with an alert generated by the image processing engine 102 to allow the IUISS user to validate a current situation and perform threat assessment as part of the alert processing. In addition to the live view from the alert-associated camera, the IUI 401 allows the IUISS user to select other cameras 101a, 101b to check the live view for assessing the overall situation. In an embodiment, the live view panel 406 allows the IUISS user to switch cameras 101a, 101b to view a live image stream from different cameras 101a, 101b belonging to the account. Switching cameras 101a, 101b allows the IUISS user to view whether an interest element, for example, a person and/or vehicle, determined by the image processing engine 102, is moving around. In a further embodiment, the live view panel 406 allows the IUISS user to switch to different views of other cameras 101a, 101b at the same site.

The alert information panel 407 displays information associated with the alert. For example, the alert information panel 407 displays that a person was detected, time of receipt of the alert, account ID, account name, camera name, area name, etc. The alert image history panel 408 displays, for example, images of previous alerts generated, previous alerts from subscribed accounts, images before and after an alert is triggered by the image processing engine 102, when available, with a scroll button displaying up to 10 images, etc. The action panel 409 allows the IUISS user to perform response actions associated with the alert, for example, abort an alert, dispatch an alert to security personnel or the external response system 109, reopen an alert, close an alert, etc. In an embodiment, the action panel 409 allows the IUISS user to move the alert to different states, such as abort, dispatch, close, and reopen, based on a threat level. For example, the IUISS user may move the alert to an abort state when the alert is a false alert that does not contain a relevant detection or event. In another example, the IUISS user may move the alert to a close state when the alert includes a relevant detection or event but is not suspicious or a threat. In a further example, the IUISS user may move the alert to a dispatch state when the alert includes a relevant detection or event and is suspicious, thereby requiring the IUISS user to dispatch an alert to security personnel or the external response system 109 to have a person come to physically check the event or call security. The IUISS user may update the state of the alert in the action panel 409 and enter notes or messages in a text field provided in the action panel 409.

The logs panel 410 displays logs of previous alerts for the same view, a list of response actions executed on the alert, etc. The action guide 411 displays instructions explaining how to respond to an alert. The alert processing page 404 displays the action guide 411 for use by security personnel such as guards to determine what response actions should be taken for the alert such as when and who to call on the ground. In an embodiment, the IUI 401 allows administrators to define standard operating procedures (SOPs) for responding to alerts at an account level. Each account can have different SOP settings, for example, a phone number to call when a suspicious activity is viewed. The IUI 401 allows the administrators to fill in and edit these SOPs. The alert processing page 404 allows each IUISS user to view the alert response SOPs at the action guide 411. In an example, the action guide 411 operates as a “ready-reckoner” while handling alerts. In an embodiment, the alert processing page 404 displays interface elements 412 configured to allow the IUISS user, for example, to play a message or send their voice live to speakers, activate lights at a site where a camera 101a, 101b is installed to desist an intruder, etc. In an embodiment, the IUI 401 captures any action taken on the alerts, either manual or automatic, for example, in text form and transmits the action information to the control unit 106. The control unit 106, in communication with all pages of the IUI 401, logs the images and the user actions and inputs for analytics. The IUISS user may view the logged responses to an alert in the logs panel 410 of the alert processing page 404.

In an embodiment, the IUI surveillance system 100 performs live alert monitoring. When an alert is generated, the control unit 106 notifies the alerts to subscribed users immediately to allow the users to take action. The control unit 106 transmits the alerts to the users through multiple notification mechanisms, for example, mobile applications, desktop portals, email, SMS messages, etc. The IUI 401 allows the users to select the notification mechanisms through which they receive the alerts.

FIG. 4F illustrates a screenshot of the IUI 401 displaying a camera wall page 413. When the IUISS user selects the “Camera Wall” item on the IUI 401, the IUI 401 displays the camera wall page 413 comprising the latest frames from each of the cameras 101a, 101b installed at a particular site for overall situational awareness. For example, the camera wall page 413 displays a back overview panel, a back right panel, a left entrance panel, a left lot panel, a right entrance panel, a right lot panel, and a sideway panel showing the latest frames from the corresponding cameras 101a, 101b. In an embodiment, the camera wall page 413 allows the IUISS user to start and view a live view of an image stream on-demand from all the cameras 101a, 101b.

FIG. 4G illustrates a screenshot of the IUI 401 displaying an analytics page 414. When the IUISS user selects the “Analytics” item on the IUI 401, the IUI 401 displays the analytics page 414 comprising various options for analytics for each camera 101a, 101b. The control unit 106 executes different types of analytics for determining the effectiveness of the IUI surveillance system 100. These analytics can either be viewed on or downloaded from the analytics page 414 in one or more formats, for example, a Comma-Separated Values (CSV) format, a Portable Document Format (PDF), etc. The analytics page 414 provides access to multiple analytics reports that are generated based on alerts and response actions executed on the alerts. For example, one or more of the analytics reports allow users such as administrators to determine how many alerts have been handled by remote monitoring agents. In another example, one or more of the analytics reports provide information on all the alerts that have been closed, or aborted, or dispatched. In an embodiment, the analytics page 414 allows the users to download the analytics reports, for example, as PDF files.

The analytics page 414 allows the IUISS user to select a camera 101a, 101b and generate analytics reports comprising, for example, an alerts by hour report, an alerts summary report, a camera activity report, a camera settings report, a person recognition report, a vehicle recognition report, a fallen person report, a mask compliance report, a guard tracking report, a dispatch report, an abort report, and a closure report, associated with the selected camera 101a, 101b. In an embodiment, the analytics page 414 allows the IUISS user to select a time range of, for example, up to the last 180 days, for the analytics data. The analytics data included in the various analytics reports comprises, for example, alert analytics data, alert response analytics data, number of raw images and clips per camera, guard location tracking data, camera settings, and external response analytics data.

The alert analytics data comprises, for example, number of alerts on a per-camera basis, alert types, total number of alerts, etc. The alert response analytics data comprises, for example, reports of alerts with different responses such as report on aborted alerts, closed alerts, and dispatched alerts. The analytics page 414 allows the IUISS user to download a snapshot of the alerts as a PDF. The number of raw images and clips per camera provides information on the total number of processed images and clips by camera 101a, 101b, which can be used to finetune the camera settings. In an embodiment, the IUI surveillance system 100 further comprises a mobile application deployable on a user device, for example, a guard user's mobile device. The mobile application allows the control unit 106 to track the location of users, for example, guard users, with their consent, and generate guard location tracking data. The guard location tracking data comprises, for example, a roaming schedule and historical locations of the guard users. The analytics page 414 also allows the IUISS user to download camera settings for further review. The external response analytics data comprises, for example, external response statistics, collected and provided as part of the analytics page 414.

FIG. 4H illustrates a screenshot of the IUI 401 displaying a camera settings page 415. When the IUISS user selects the “Camera Settings” item on the IUI 401, the IUI 401 displays the camera settings page 415 comprising settings for the cameras 101a, 101b to be configured by the IUISS user. The camera settings page 415 allows the IUISS user to arm or disarm a camera 101a, 101b, thereby enabling or disabling detection and alert generation mechanisms of the IUI surveillance system 100. The camera settings page 415 further allows the IUISS user to schedule detection and alert generation, select modules for alert detection, for example, vehicle plate number detection, fallen person detection, mask compliance detection, etc., associate a speaker to a camera 101a, 101b, etc. The camera settings page 415 further allows the IUISS user to select a type of camera 101a, 101b to allow specific parameters to be set for that specific camera type and set various camera settings comprising, for example, brightness, contrast, detection decision thresholds, etc. The camera settings page 415 further allows the IUISS user to set an area in the camera view for alert detection, for example, to allow excluding persons or vehicles outside a region of interest in the camera view as illustrated in FIG. 4H.

In an embodiment, the cameras 101a, 101b are implicitly created in the IUI surveillance system 100 when the cameras 101a, 101b initiate transmission of images to the control unit 106. The control unit 106 creates the cameras 101a, 101b to be part of an account. In an embodiment, external systems are configured to transmit additional information or metadata with the images to allow the images to be associated with the right account. The additional information comprises, for example, account and camera identifiers. Each camera 101a, 101b comprises its own editable settings and configuration parameters that are modifiable at a camera level. The pipeline of AI modules 104 and the post-processing module 105 utilize the camera settings in the processing of the images. The parameters of each camera 101a, 101b are configured based on factors, for example, camera environment such as indoor and/or outdoor, resolution, type such as color, infrared (IR), etc., and enable accurate object detection and alert generation by the pipeline of AI modules 104 and the post-processing module 105.

In an embodiment, alerting devices 108, for example, speakers, are installed as part of IUI surveillance system 100 as a method of deterrence to play alerts or warnings either manually or automatically. In an embodiment, these speakers are Internet Protocol (IP)-enabled and remotely accessible using Representational State Transfer (REST) Application Programming Interfaces (APIs). In various embodiments, the speakers are implemented in different modes, for example, an automatic (auto)-talkdown mode, a manual pre-recorded talkdown mode, a push-to-talk mode, etc. In the auto-talkdown mode, recorded audio clips are played automatically when an alert is generated. In the manual pre-recorded talkdown mode, the speakers are configured with recorded audio clips, which can be played manually by the IUISS user. In the push-to-talk mode, the IUISS user may initiate a live call and speak. In an embodiment, the speakers are configured via the IUI 401. The configuration of the speakers comprises, for example, an address, a username, a password, and different clips that are required to be played.

Users may have multiple cameras 101a, 101b and speakers that the user would like to associate the speakers with one or more cameras 101a, 101b based on the position and field of view. In an embodiment, the IUI 401 allows each camera 101a, 101b to be mapped with one or more speakers, when available, to allow the alerts to trigger, for example, the auto-talkdown mode, that is, playing of audio clips. The IUI surveillance system 100 is configured to automatically play a pre-selected message on a speaker when an alert is generated, to create a deterrence against intruders. The speakers can be mapped to one or more cameras 101a, 101b to allow the alert(s) from the camera(s) 101a, 101b to play an audio message through the speakers. The same messages can be played on demand by a user, which is referred to as manual talkdown, which is useful for repeating the messages or selecting different messages based on the situation. In addition to automatic playing of audio clips or messages, the speakers with Session Initiation Protocol (SIP) support can be called by a user, for example, a monitoring agent, to speak to an intruder directly and warn them. In various embodiments, one or more of the alerting devices 108, for example, one or more speakers and/or lights are associated with the account via the IUI 401. In an embodiment, the control unit 106 configures the speakers to store different message clips in the form of audio files. In another embodiment, the control unit 106, via the IUI 401, records messages to be played at the speakers. In the auto talkdown mode and the manual pre-recorded talkdown mode, the speakers are configured to programmatically play any audio clip in any sequence, which is useful when audio is conversational. In an embodiment, the control unit 106 is configured to play these audio clips based on a threat level identified by the image processing engine 102.

FIG. 4I illustrates an enlarged view of a portion of the camera settings page 415 shown in FIG. 4H. In an embodiment, the camera settings page 415 allows the IUISS user to select the AI modules 104 illustrated in FIG. 1, to be used for performing image processing functions, for example, person detection, face recognition, fall detection, vehicle detection, license plate recognition, etc. In an embodiment, the camera settings page 415 renders a window 416 to allow the IUISS user to select detection for a region of interest. The window 416 comprises an interface element 417 for allowing the IUISS user to set a region of interest for the detection. In a further embodiment, the camera settings page 415 renders alert interval and limiting controls to allow the IUISS user to configure a minimum interval to be maintained between two alerts of the same type. In another embodiment, the camera settings page 415 allows the IUISS user to configure the number of alerts per time window, for example, 30 minutes, 1 hour, etc., to reduce the frequency of alerts when not needed.

In various embodiments, the camera settings page 415 displays configuration settings, for example, for scheduling, arming, and disarming cameras. The camera settings page 415 allows the IUISS user to configure the cameras 101a, 101b to be armed or enabled for image processing, disarmed or disabled, or scheduled for processing of the images only during a given schedule. In an example, the camera settings page 415 allows the IUISS user to schedule the cameras 101a, 101b to capture and transmit images to the control unit 106 by activating a “Scheduled” mode on the camera settings page 415. In another example, the camera settings page 415 allows the IUISS user to configure the cameras 101a, 101b to transmit the captured images by activating an “Arm” mode on the camera settings page 415. In a further example, the camera settings page 415 allows the IUISS user to disable the cameras 101a, 101b by activating a “Disarm” mode in the camera settings page 415.

FIG. 4J illustrates a screenshot of the IUI 401 displaying a panel 418 for setting a region of interest. When the IUISS user clicks on the interface element 417 rendered on the window 416 of the camera settings page 415 illustrated in FIG. 4I, the IUI 401 displays the panel 418 to allow the IUISS user to select a region of interest. The panel 418 allows the IUISS user to draw a region of interest on the camera view to indicate that alerts should be processed only if they are inside the selected region of interest. The panel 418 allows the IUISS user to draw regions of interest on a per-camera level and a per-feature level, thereby defining custom regions for each feature that they are using. For example, the IUISS user may draw different regions of interest for person detection and vehicle detection which may or may not overlap.

FIG. 4K illustrates a screenshot of the IUI 401 displaying a panel 418 for setting a region of disinterest. When the IUISS user clicks on the interface element 417 rendered on the window 416 of the camera settings page 415 illustrated in FIG. 4I, the IUI 401 displays the panel 418 to allow the IUISS user to select a region of disinterest. The panel 418 allows the IUISS user to draw a region of disinterest on the camera view to indicate that alerts should not be processed if they are inside the selected region of disinterest. The panel 418 allows the IUISS user to draw regions of disinterest on a per-camera level and a per-feature level, thereby defining custom regions for each feature that they are using. For example, the IUISS user may draw different regions of disinterest for excluding person detection and vehicle detection which may or may not overlap. Defining a region of disinterest allows the surveillance system to ignore areas that are not relevant for monitoring, such as roads with constant traffic, moving trees, reflections, etc. By excluding these irrelevant areas/zones, the surveillance system reduces false positives, conserves storage and processing resources, and ensures that alerts are generated only for activity occurring in the regions of interest. This not only improves the accuracy and reliability of detection but also helps operators stay focused on genuine security threats rather than being distracted by irrelevant events.

FIG. 4L illustrates a screenshot of the IUI 401 displaying the analytics page 414 through which the IUISS user may monitor guards allocated to respond to the alerts. When the IUISS user clicks on a “Guard Tracking” interface element 419 on the analytics page 414, the control unit 106 renders a guard tracking report 421 on the analytics page 414. The guard tracking report 421 provides tracking data that allows the IUISS user to monitor the guards who consent and allow themselves to be tracked using their user devices, for example, cellphones. The guard tracking report 421 provides statistics and real-time information comprising, for example, time to respond to an alert, distance from the site, etc.

In an embodiment, the IUI 401 renders a guard monitoring portal configured to be utilized by remote monitoring agents assigned to remotely monitor the cameras 101a, 101b, selected actionable alerts, and at least part of the resultant data for executing the response actions. The guard monitoring portal allows the remote monitoring agents to view the AI-processed alerts, images, and live views from the cameras 101a, 101b remotely. The remote monitoring agents may execute necessary response actions after reviewing the alerts and the live views from the cameras 101a, 101b to determine whether there is any suspicious activity and whether to dispatch local or patrol guards to the site. In an embodiment, the guard monitoring portal is set up to allow one remote monitoring agent to monitor cameras 101a, 101b across various customer accounts. This setup enables security and monitoring service providers to assign the same guard to monitor multiple accounts. In an embodiment, the users of the guard monitoring portal, namely, guard users, administrators, etc., are assigned with different privilege levels. The guard users have fewer privileges, where they can view and update the alerts, view raw image streams from the cameras 101a, 101b, and check the live views of the cameras 101a, 101b. The administrators of the guard monitoring portal have additional privileges, where they can manage administrative functionalities comprising, for example, adding/deleting new guard users, creating and assigning guard schedules to customer accounts, accessing analytics information, and guard grouping management.

In an embodiment, the guard monitoring portal provides a scheduling tool to allow users to manage scheduling for the accounts. Each account may have to be monitored for specific time periods, for example, only during specific hours based on customer requirements. The scheduling tool allows the users to set up these schedules, for example, 9 pm to 5 am, and apply the set schedules to the accounts based on customer requirements. The guard monitoring portal transmits notifications associated with AI alerts generated for the cameras 101a, 101b in the accounts to the guard users only during the scheduled hours.

In an embodiment, the guard monitoring portal is configured to monitor multiple accounts and allow grouping of guards. The guard monitoring portal transmits alerts from different accounts during a time slot to the guards. Consider an example scenario where each time slot of monitoring may need more than one guard to address alerts as soon as they arrive. In another example scenario, guards may change or get replaced. To handle these scenarios, the guard monitoring portal allows creation of guard groups. Each guard group comprises one or more guards. The guard monitoring portal transmits the same alerts to all the guards in a particular group. Instead of assigning individual guards, an administrator assigns a guard group to monitor each account. The addition or removal of a guard to or from a guard group does not affect the monitoring, since all the guards in a guard group receive the same alerts. In an embodiment, the guard monitoring portal logs alerts, guard actions, and response times.

FIG. 4M illustrates a screenshot of an abort report 422 generated by the control unit 106. When the IUISS user clicks on an “Abort Report” interface element 420 on the analytics page 414 illustrated in FIG. 4K, the control unit 106 renders the abort report 422 illustrated in FIG. 4L. The abort report 422 provides information on all the alerts that have been aborted and the reasons for the abort response action. Similarly, the control unit 106 renders a closure report comprising information on all the alerts that have been closed and the reasons for the closure response action. Furthermore, the control unit 106 renders a dispatch report comprising information on all the alerts that have been dispatched to boots-on-the ground personnel and the reasons for the dispatch response action. The analytics page 414 allows users to download these reports, for example, as PDF files.

FIG. 4N illustrates a screenshot of the IUI 401 displaying an image history page 423. The image processing engine 102 and/or the control unit 106 store all images and clips that are received from the cameras. The control unit 106 provides access to the stored images and clips via the IUI 401 for viewing by users in a separate page. When the IUISS user selects the “Image History” item on the IUI 401, the IUI 401 displays the image history page 423 comprising the images captured by a particular camera 101a, 101b for a particular customer. The IUI 401 allows the users to analyze raw images and clips on the image history page 423. In an embodiment, the IUI 401 allows the users to select a camera 101a, 101b from a dropdown list and view the images and/or clips on the displayed image history page 423.

FIG. 4O illustrates a screenshot of another camera settings page 424 for configuring multiple camera settings of each camera 101a, 101b for each account. When the IUISS user selects the “Camera Settings” item on the IUI 401, the IUI 401 displays the camera settings page 424 comprising multiple camera settings that are configurable by users. The camera settings comprise, for example, contrast, brightness, detection thresholds, detection modules, and regions of interest. In an embodiment, the camera settings page 424 allows the IUISS user to add a reference image, configure settings to conduct a camera health check, identify a Field-Of-View (FOV) mismatch, etc. The camera settings page 424 renders interface elements, for example, knobs, to activate or deactivate camera health check and FOV mismatch settings.

FIG. 4P illustrates a screenshot of the IUI 401 displaying a safe list/watch list 425 generated by the image processing engine 102. In an embodiment, the image processing engine 102 categorizes interest elements, for example, faces, vehicles, etc., in the identified regions of interest, as known, unknown, or unidentifiable. In an embodiment, the AI module(s) 104 illustrated in FIG. 1, further classifies the known interest elements as trusted on a safe list, and untrusted on a watch list. In an example, the safe list/watch list 425 displays the number of trusted faces found, the number of untrusted faces found, and the number of unknown faces as illustrated in FIG. 4O. In an embodiment, the safe list/watch list 425 allows the user to set a safe list and/or a watch list for license plate recognition and face recognition.

FIG. 4Q illustrates a screenshot of the IUI 401 displaying an administration (admin) page 426. When the IUISS user selects the “Admin” item on the IUI 401, the IUI 401 displays the admin page 426. The admin page 426 allows an administrator to create user accounts. The admin page 426 renders interface elements 427, 428, and 429, for example, for adding a user, configuring a Simple Mail Transfer Protocol (SMTP), and generating an audit trail, respectively. In an embodiment, the control unit 106 allows creation of an account when a camera monitoring system is onboarded for use with the IUI surveillance system 100. The account is configured to have multiple cameras 101a, 101b which are either connected to the same IUI surveillance system 100, or are part of the same site or location. Each account comprises details, for example, account name, input and output integration details, associated users, cameras 101a, 101b, etc. In an embodiment, the administrator creates accounts as part of an onboarding process. The admin page 426 allows the administrator to view and modify properties of the created accounts. Each account is uniquely identified, for example, by an alphanumeric identifier. When the administrator clicks on an “Audit Trail” interface element 429 on the admin page 426, the admin page 426 displays the audit logs for viewing by the administrator. The audit logs comprise information on all user actions performed on the IUI 401. In an embodiment, the admin page 426 provides links to the guard monitoring portal disclosed in the description of FIG. 4K.

In an embodiment, the IUI 401 further comprises a user management module configured to add users for managing the IUI 401. In an embodiment, the addition of users by the user management module follows a standard two-factor authentication-based user creation flow. The user management module allows new users to be added with different privilege levels and allows them to receive different types of notifications. In an embodiment, the user management module schedules transmission of alerts to the users.

FIG. 4R illustrates a screenshot of an account setup page 430. The account setup page 430 allows setting up of a user account. In an embodiment, the account setup page 430 allows setting up of a Simple Mail Transfer Protocol (SMTP) for transmitting email notifications associated with alerts over a network 601, shown in FIG. 6. The account setup page 430 provides a field for entering an email address to which email notifications and images when motion is detected are transmitted.

In various embodiments, the image capture devices 101, for example, cameras 101a, 101b, of the IUI surveillance system 100 support motion detection with SMTP integration. The cameras 101a, 101b are configured to transmit images to the image processing engine 102 of the IUI surveillance system 100 whenever they detect motion. The IUI surveillance system 100 comprises an onboarding platform configured to generate a new email address in in-house SMTP servers managed by the IUI surveillance system 100 and utilize these SMTP servers as SMTP senders. Therefore, the onboarding platform allows a user to onboard a camera 101a, 101b to the IUI surveillance system 100 without having to use their own email address. The onboarding procedure does not require any change in the hardware and allows users to set up the SMTP with minimal configuration steps. The onboarding platform configures the email processes to support different types since each type of camera 101a, 101b or Network Video Recorder (NVR) has its own format for transmitting the images and metadata. In an embodiment, the IUI surveillance system 100 further comprises an SMTP processor (not shown) configured to support an extensive set of NVR and camera email formats. In a further embodiment, the IUI surveillance system 100 further comprises an automatic parser (not shown) configured to automatically detect the format of the email and parse accordingly. Furthermore, the onboarding platform allows users to select the type of the camera 101a, 101b or the NVR from a dropdown menu that assigns the automatic parser. The email metadata comprising, for example, a sender identifier (ID), subject, etc., is used to identify the source to utilize appropriate parsing techniques.

FIG. 4S illustrates a screenshot of a notification setup page 431. Users may select different methods for receiving alert notifications from the IUI surveillance system 100. These methods comprise, for example, a mobile application notification, an email notification, a text message notification, etc. Furthermore, the notification setup page 431 provides users the option to receive email reports for different scenarios, for example, when a new camera 101a, 101b is added, when cameras 101a, 101b have been idle, when a mobile site has been moved beyond a certain distance by utilizing geolocation provided by a cellular router, etc.

FIGS. 5A-5D illustrate screenshots showing Graphical User Interface (GUI) 501 rendered by a mobile application deployed on a user device for facilitating intelligent user interface (IUI) surveillance. The mobile application allows users to view and modify alerts, view the images, watch a live view, and receive alert notifications. The mobile application also supports viewing historical alerts and talkdown such as an automatic (auto) talkdown, a manual pre-recorded talkdown, push-to-talk, etc., as disclosed in the description of FIG. 4H. The alerts viewable in the mobile application are the same as those viewable in the desktop-based application. The alert updates and actions are visible across both the mobile and desktop platforms. The mobile application is useful for guards who are onsite and physically checking the alerts.

The GUI 501 of the mobile application is configured as intelligent user interface (IUI) to display resultant data comprising, for example, actionable alerts, and receive user inputs. FIG. 5A illustrates a screenshot of the GUI 501 of the mobile application, displaying a login page 502 that allows a user to login to the mobile application using authentication credentials, for example, an email address and a password. On logging into the mobile application, the GUI 501 displays an alert page 503 comprising alerts generated by the image processing engine 102 and received from the control unit 106 of the IUI surveillance system 100 as illustrated in FIG. 5B. The alert page 503 provides information comprising, for example, detections, timestamps, site name, camera location, etc., of each alert. The alert page 503 allows the user to review the alerts, abort the alerts, dispatch the alerts, close the alerts, or comment on the alerts. The GUI 501 also displays an image history page 504 allowing the user to view previous images from each camera 101a, 101b, alert history, alert response history, etc., as illustrated in FIG. 5C. Furthermore, the mobile application allows the user to start and view a live image stream on-demand from different cameras 101a, 101b at different locations. For example, the mobile application may obtain a live view from cameras 101a, 101b at the back, back right, a left entrance, a left lot, a right entrance, a right lot, a sideway, etc., which show the latest frames from the corresponding cameras 101a, 101b. The GUI 501 displays an accounts page 505 allowing the user to select an account and the location for the live view as illustrated in FIG. 5D.

FIG. 6 illustrates an architectural block diagram of an exemplary implementation of an embodiment of the intelligent user interface(IUI) surveillance system 100 for facilitating IUI surveillance. In the exemplary implementation, the IUI surveillance system 100 comprises one or more image capture devices, herein referred to as cameras 101a, 101b, and 101c, and an Artificial Intelligence (AI)-enabled platform 612. While FIG. 6 shows three cameras 101a, 101b, and 101c for purposes of illustration, the IUI surveillance system 100 disclosed herein is not limited to three cameras 101a, 101b, and 101c, but extends to include any number of cameras 101a, 101b, 101c, . . . , 101n. Each of the cameras 101a, 101b, and 101c captures and selectively transmits an image stream associated with a surveillance area via a network 601. Each of the cameras 101a, 101b, and 101c may transmit, for example, individual frames, batches of frames, video clips, or video feeds via a video cable, Ethernet, or other methods of data transfer such as an internet connection, using one of any data transfer protocols.

In an embodiment as illustrated in FIG. 6, the artificial intelligence-enabled platform 612 comprises multiple computing servers 602 programmable using high-level computer programming languages. In an embodiment, the artificial intelligence-enabled platform 612 is implemented on an electronic device, for example, a workstation, a client device, one or more servers, a network-enabled computing device, an interactive network-enabled communication device, any other suitable computing equipment, combinations of multiple pieces of computing equipment, etc. In another embodiment, the artificial intelligence-enabled platform 612 is implemented in a cloud computing environment. As used herein, “cloud computing environment” refers to a processing environment comprising configurable, computing, physical and logical resources, for example, networks, servers, storage media, virtual machines, applications, services, etc., and data distributed over the network 601. The cloud computing environment provides an on-demand network access to a shared pool of the configurable computing physical and logical resources. In an embodiment, the artificial intelligence-enabled platform 612 is a cloud-based platform implemented as a service for facilitating intelligent user interface (IUI) surveillance. For example, the artificial intelligence-enabled platform 612 is configured as a software as a service (Saas) platform or a cloud-based software as a service (CSaaS) platform that facilitates intelligent user interface (IUI) surveillance. In an embodiment, the artificial intelligence-enabled platform 612 is configured as a server or a network of servers in a cloud computing platform, for example, the Amazon Web Services (AWS®) platform of Amazon Technologies, Inc., the Microsoft Azure® platform of Microsoft Corporation, etc. Each computing server 602 is responsible for a particular portion of the artificial intelligence-enabled platform procedures and functions as backend enablers of the image processing engine 102. In another embodiment, the artificial intelligence-enabled platform 612 is implemented locally as an on-premise platform comprising on-premise software installed and run on client systems on the premises of an organization to meet surveillance and security requirements.

The computing servers 602 of the artificial intelligence-enabled platform 612 comprising multiple modules of the image processing engine 102 are accessible to users, for example, IUISS users, administrators, remote monitoring agents, security personnel such as guard users, etc., through a broad spectrum of technologies and user devices such as personal computers, laptops, internet-enabled cellular phones, smartphones, tablet computing devices, portable cameras, etc., with access to the internet. In an embodiment, the AI-enabled platform 612 integrates with existing workflow seamlessly to automatically pull images into the image processing engine 102. In a further embodiment, the AI-enabled platform 612 is employed by customers as an enhanced imaging software in an existing workflow, where updates are made via the cloud automatically with no installation required. In other embodiments, the artificial intelligence-enabled platform 612 runs machine learning (ML) on a cloud machine learning platform, without the need for graphics processing unit (GPU) acceleration during inference time.

The artificial intelligence-enabled platform 612 is in operable communication with the cameras 101a, 101b, and 101c and with multiple user devices 611a and 611b, for example, of IUISS users, remote monitoring agents, guard users, etc. The user devices 611a and 611b are electronic devices, for example, personal computers, tablet computing devices, mobile computers, mobile phones, smartphones, portable computing devices, laptops, personal digital assistants, wearable computing devices such as smart glasses, touch centric devices, workstations, client devices, portable electronic devices, network-enabled computing devices, interactive network-enabled communication devices, image capture devices, web browsers, portable media players, any other suitable computing equipment, combinations of multiple pieces of computing equipment, etc. In an example, the user device 611a is associated with an IUISS user who tunes parameters for the cameras 101a, 101b, and 101c and the artificial intelligence modules 104 via the IUI 107. In another example, the user device 611b is associated with a guard user who provides consent to be tracked and monitored via the mobile application deployed on the user device 611b.

The network 601 is a short-range network or a long-range network, for example, one of the internet, satellite internet, an intranet, a wired network, a wireless network, a communication network that implements Bluetooth® of Bluetooth Sig, Inc., a network that implements Wi-Fi® of Wi-Fi Alliance Corporation, an ultra-wideband (UWB) communication network, a wireless universal serial bus (USB) communication network, a communication network that implements ZigBee® of ZigBee Alliance Corporation, a General Packet Radio Service (GPRS) network, a mobile telecommunication network such as a Global System for Mobile (GSM) communications network, a Code Division Multiple Access (CDMA) network, an Nth generation (NG) mobile communication network, where “N” is, 2, 3, 4, 5, 6, etc., a Long-Term Evolution (LTE) mobile communication network, a public telephone network, etc., a local area network, a wide area network, an internet connection network, an infrared communication network, etc., or a network formed from any combination of these networks.

The artificial intelligence-enabled platform 612 interfaces with the cameras 101a, 101b, and 101c and the user devices 611a and 611b, and in an embodiment, with one or more database systems (not shown) and servers (not shown) to implement the AI-powered intelligent user interface (IUI) surveillance system 100, and therefore more than one specifically programmed computing system is used for implementing the AI-powered IUI surveillance service. In an embodiment, the artificial intelligence-enabled platform 612, the cameras 101a, 101b, and 101c, and the user devices 611a and 611b, constitute interconnected components of the IUI surveillance system 100 that are deployed at different locations, but all coordinate with each other through the network 601.

In an embodiment, the image processing engine 102 is deployed and implemented in the computing servers 602 of the artificial intelligence-enabled platform 612 using programmed and purposeful hardware as exemplarily illustrated in FIG. 6. In an embodiment, the image processing engine 102 is a computer-embeddable system that facilitates IUI surveillance. As exemplarily illustrated in FIG. 6, each of the computing servers 602 of the artificial intelligence-enabled platform 612 comprises a non-transitory, computer-readable storage medium, for example, a memory unit 606, for storing computer program instructions defined by modules, for example, 102a, 102b, 102c, 102d, 102e, 102f, 102g, 102h, 102i, etc., of the image processing engine 102. As used herein, “non-transitory, computer-readable storage medium” refers to all computer-readable media that contain and store computer programs and data. Examples of the computer-readable media comprise hard drives, solid state drives, optical discs or magnetic disks, memory chips, a read-only memory (ROM), a register memory, a processor cache, a random-access memory (RAM), etc. Each of the computing servers 602 of the artificial intelligence-enabled platform 612 further comprises at least one processor 603 operably and communicatively coupled to the memory unit 606 for executing the computer program instructions defined by the modules, for example, 102a to 102h of the image processing engine 102. The memory unit 606 is a storage unit used for recording, storing, and reproducing data, program instructions, and applications. In an embodiment, the memory unit 606 comprises a random-access memory (RAM) or another type of dynamic storage device that serves as a read and write internal memory and provides short-term or temporary storage for information and instructions executable by the processor(s) 603. The memory unit 606 also stores temporary variables and other intermediate information used during execution of the instructions by the processor(s) 603. In another embodiment, the memory unit 606 further comprises a read-only memory (ROM) or another type of static storage device that stores firmware, static information, and instructions for execution by the processor(s) 603.

In an embodiment, engine module(s) 607, for example, the modules 102a to 102i of the image processing engine 102, are stored in the memory unit 606 of any one or more of the computing servers 602 of the artificial intelligence-enabled platform 612. For purposes of illustration, the engine module(s) 607 is exemplarily shown to be a part of an in-memory system of each computing server 602 in FIG. 6; however, the scope of the intelligent user interface (IUI) surveillance system 100 disclosed herein is not limited to the engine module(s) 607 being part of an in-memory system, but extends to the engine module(s) 607 being distributed across a cluster of multiple computer systems, for example, computers, servers, virtual machines, containers, nodes, etc., coupled to the network 601, where the computer systems operate as a team and coherently communicate and coordinate with each other to share resources, distribute workload, and execute different portions of the logic to implement IUI surveillance functions as a service. Each computer system in the cluster executes a part of the logic, and coordinates with other computer systems in the cluster to provide the complete functionality of the IUI surveillance system 100 and the method disclosed herein.

The processor(s) 603 in any one or more of the computing servers 602 is configured to execute the engine module(s) 607 for facilitating intelligent user interface (IUI) surveillance. The engine module(s) 607, when loaded into the memory unit 606 and executed by the processor(s) 603, transforms the corresponding computing server 602 into a specially-programmed, special purpose computing device configured to implement the functionality disclosed herein. The processor(s) 603 refers to one or more microprocessors, central processing unit (CPU) devices, finite state machines, computers, microcontrollers, digital signal processors, logic, a logic device, an application specific integrated circuit (ASIC), a field-programmable gate array (FPGA), a chip, etc., or any combination thereof, capable of executing computer programs or a series of commands, instructions, or state transitions. In an embodiment, the processor(s) 603 is implemented as a processor set comprising, for example, a programmed microprocessor and a math or graphics co-processor. The image processing engine 102 is not limited to employing the processor(s) 603. In an embodiment, the image processing engine 102 employs a controller or a microcontroller.

Also illustrated in FIG. 6, is a data bus 610, a display unit 608, a network interface 604, and common modules 609 of the computing server 602. The data bus 610 permits communications and exchange of data between the components, for example, 603, 604, 605, 606, 608, and 609 of the computing server 602. The data bus 610 transfers data to and from the memory unit 606 and into or out of the processor(s) 603. The display unit 608, via a graphical user interface (GUI), herein referred to as the IUI 107, displays IUI elements such as input fields for allowing a user, for example, an IUISS user to input data such as tuning parameters for the cameras 101a, 101b, and 101c, the identification of the regions of interest, the determination of the interest elements, and the artificial intelligence modules 104 into the artificial intelligence-based platform 612. Moreover, the display unit 608, via the IUI 107, displays IUI elements such as input fields for allowing the IUISS user to indicate false positives, define exclusion zones within the surveillance area to reduce false positives, annotate and correct the determined interest elements in the identified regions of interest, etc. Furthermore, the display unit 608, via the IUI 401 illustrated in FIGS. 4A-4R, displays the alert display page 402, the alert management page 403, the alert processing page 404, the camera wall page 413, the analytics page 414, the image history panel 408, the camera settings page 415, etc. In an embodiment, the IUI 107 is rendered on the user device 611a and 611b for allowing the IUISS user to indicate false positives in the alerts generated by the image processing engine 102. The IUI 107 comprises, for example, any one of an online web interface, a web-based downloadable application interface, a mobile-based downloadable application interface, etc.

The network interface 604 is configured to connect the computing server 602 of the artificial intelligence-enabled platform 612 to the network 601. In an embodiment, the network interface 604 is provided as an interface card also referred to as a line card. The network interface 604 is, for example, one or more of infrared interfaces, interfaces implementing Wi-Fi® of Wi-Fi Alliance Corporation, universal serial bus (USB) interfaces, Ethernet interfaces, frame relay interfaces, cable interfaces, digital subscriber line interfaces, token ring interfaces, peripheral component interconnect (PCI) interfaces, local area network (LAN) interfaces, wide area network (WAN) interfaces, interfaces using serial protocols, interfaces using parallel protocols, asynchronous transfer mode interfaces, fiber distributed data interfaces (FDDI), interfaces based on transmission control protocol (TCP)/internet protocol (IP), interfaces based on wireless communications technology such as satellite technology, radio frequency technology, near field communication, etc.

The storage device(s) 605 comprise non-transitory, computer-readable storage media, for example, fixed media drives such as hard drives for storing an operating system, application programs, data files, etc. ; removable media drives for receiving removable media; etc. The common modules 609 comprise, for example, input/output (I/O) controllers, input devices, output devices, fixed media drives such as hard drives, removable media drives for receiving removable media, etc. The output devices output the results of operations performed by the image processing engine 102. For example, the image processing engine 102 renders the resultant data comprising the alerts to IUISS users using the output devices. Computer applications and programs are used for operating the artificial intelligence-enabled platform 612. The programs are loaded onto fixed media drives and into the memory unit 606 via the removable media drives. In an embodiment, the computer applications and programs are loaded into the memory unit 606 directly via the network 601.

The engine module(s) 607 is deployed and implemented in the computing and networking server(s) 602 of the artificial intelligence-enabled platform 612 using programmed and purposeful hardware. In an embodiment, the engine modules 607 are computer-embeddable systems that facilitates intelligent user interface (IUI) surveillance. In an exemplary implementation illustrated in FIG. 6, the engine modules 607 of the image processing engine 102 comprises an image reception module 102a, a Region-Of-Interest (ROI) detection module 102c, an interest element determination module 102d, an alert data generation module 102e, an analytics module 102f, a camera health check module 102g, an image database 102h, and a guard management module 102i. In an embodiment, the image reception module 102a and the ROI detection module 102c constitute the motion filtering and preprocessing module 103 of the image processing engine 102 illustrated in FIG. 1; the interest element determination module 102d constitutes one or more of the AI modules 104 of the image processing engine 102 illustrated in FIG. 1; and the alert data generation module 102e, the analytics module 102f, the camera health check module 102g, and the guard management module 102i constitute the post-processing module 105 of the image processing engine 102 illustrated in FIG. 1.

The image reception module 102a receives the image stream from the cameras 101a, 101b, and 101c via the network 601. The image reception module 102a stores the received image stream in the image database 102h. The image database 102h is any storage area or medium that can be used for storing data and files. The image database 102h can be, for example, any of a structured query language (SQL) data store or a not only SQL (NoSQL) data store such as the Microsoft® SQL Server®, the Oracle® servers, the MySQL® database of MySQL AB Limited Company, the mongoDB® of MongoDB, Inc., the Neo4j graph database of Neo Technology Corporation, the Cassandra database of the Apache Software Foundation, the HBase® database of the Apache Software Foundation, etc. In an embodiment, the image database 102h can also be a location on a file system. In another embodiment, the image database 102h can be remotely accessed by the AI-based platform 612 via the network 601. In another embodiment, the image database 102h is configured as a cloud-based database implemented in a cloud computing environment, where computing resources are delivered as a service over the network 601. The image reception module 102a also receives and stores metadata comprising, for example, account and camera identifiers, etc., associated with the image stream in the image database 102h.

The ROI detection module 102c identifies regions of interest comprising, for example, regions of significant motion, user-specified regions of interest, etc., in the image stream. The interest element determination module 102d determines multiple interest elements comprising, for example, faces, humans, animals, vehicles, objects, markers, events, etc., in the identified regions of interest in the image stream by selectively using one or more of the artificial intelligence modules 104. In an embodiment, the interest element determination module 102d categorizes the determined interest elements, for example, into known, unknown, or unidentifiable interest elements as disclosed in the description of FIG. 1.

The alert data generation module 102e generates resultant data based on the determined interest elements and one or more conditions. The conditions comprise, for example, configurable thresholds associated with overlaps between the interest elements and the identified regions of interest, location of the interest elements, size of the interest elements, type of the interest elements, number of the interest elements, time period of detections of the interest elements, configurable schedules, field of view changes, user preferences, etc. The resultant data comprises, for example, the identified regions of interest, the identified regions of disinterest, the determined interest elements, actionable alerts, the tuning parameters, alert history, alert response history, alert response standard operating procedures, alert response statistics, information about behavior of an external response system, alerts generated by the artificial intelligence modules 104, etc. The alert data generation module 102e communicates the resultant data to the control unit 106.

The control unit 106, in operable communication with the image processing engine 102, receives the generated resultant data from the image processing engine 102 and selectively renders the generated resultant data in one or more views on the IUI 107 for review and verification. The IUI 107, in operable communication with the control unit 106, receives tuning parameters for the cameras 101a, 101b, and 101c, the identification of the regions of interest, the determination of the interest elements, and the artificial intelligence modules 104. In an embodiment, the IUI 107 generates and renders a comprehensive view of the image stream comprising real-time image frames with highlighted interest elements, and an alert history extracted from the resultant data. Moreover, the IUI 107 receives, in response to the selectively rendered resultant data, an identification of false positives. Furthermore, the IUI 107 transmits the received tuning parameters and the received identification of the false positives to the alert data generation module 102e of the image processing engine 102 via the control unit 106 for updating the artificial intelligence modules 104 and the resultant data. The updated resultant data comprises, for example, the actionable alerts, the tuning parameters, an alert history, an alert response history, alert response standard operating procedures, alert response statistics, external response system behavior information, etc. The control unit 106 executes response actions based on the updated resultant data.

In an embodiment, the control unit 106 transmits selected actionable alerts associated with the updated resultant data to an external response system 109 via the network 601. The external response system 109 comprises security personnel and remote monitoring agents assigned to remotely monitor the cameras 101a, 101b, and 101c, the selected actionable alerts, and at least part of the resultant data for executing the response actions. For example, the control unit 106 transmits the selected actionable alerts to remote monitoring agents, guard users such as security guards, police, etc., via a mobile application deployed on their user devices, via Short Message Service (SMS) messages, emails, etc. The response actions comprise, for example, rendering alert notifications in multiple modes, for example, a text mode, an email mode, an audio mode, a voice mode, a light mode, an artificial intelligence-generated mode, a real-time notification mode, media playback mode, a push-to-talk mode, etc. In an example, the remote monitoring agent may transmit a response action to an actionable alert via alerting devices 108, for example, speakers, lights, etc.

In an embodiment, the analytics module 102f performs analytics and generates analytics reports based on the updated resultant data. For example, the analytics module 102f generates reports associated with the alerts, alerts summary, camera activity, camera settings, person recognition, vehicle recognition, fallen person, mask compliance, guard tracking, alert dispatch, alert abort, alert closure, etc., as disclosed in the description of FIG. 4G. In an embodiment, the camera health check module 102g performs a health assessment of each of the cameras 101a, 101b, and 101c by checking image characteristics and frequency. In a further embodiment, the camera health check module 102g performs a color-based health check by determining whether each of the cameras 101a, 101b, and 101c generates single-colored images, which may be caused by a blockage of the view or a hardware malfunction. In an embodiment, the camera health check module 102g performs a field-of-view mismatch check by tracking historical images and determining whether there is a change in the field of view of each of the cameras 101a, 101b, and 101c. The field-of-view mismatch check detects whether a camera installation has been tampered with.

In an embodiment, the guard management module 102i monitors locations of guards and their responses to verified alerts via the guard monitoring portal disclosed in the description of FIG. 4K. In an embodiment, the guard management module 102i tracks response actions executed by remote monitoring agents after they review the alerts and the live views from the cameras 101a, 101b, and 101c to determine whether there is any suspicious activity and whether to dispatch local or patrol guards to the site. The guard management module 102i provides a scheduling tool to allow users to manage scheduling for the accounts. The guard management module 102i allows monitoring of multiple accounts and grouping of guards via the guard monitoring portal.

The processor(s) 603 in the computing server 602 of the artificial intelligence-enabled platform 612 retrieves instructions defined by the image reception module 102a, the ROI detection module 102c, the interest element determination module 102d, the alert data generation module 102e, the analytics module 102f, the camera health check module 102g, and the guard management module 102i, from the memory unit 606 for executing the respective functions disclosed above. Each engine module(s) 607 in the computing server 602 is disclosed above as software executed by the processor(s) 603. In an embodiment, the modules 102a to 102i of the image processing engine 102 are implemented completely in hardware. In another embodiment, the modules 102a to 102i of the image processing engine 102 are implemented by logic circuits to carry out their respective functions disclosed above. In another embodiment, the image processing engine 102 is also implemented as a combination of hardware and software and one or more processors 603, that are used to implement the modules, for example, 102a to 102i of the image processing engine 102.

For purposes of illustration, the disclosure herein refers to the engine module(s) 607 being run locally on a single computing server 602 of the artificial intelligence-enabled platform 612; however the scope of the intelligent user interface (IUI) surveillance system 100 and the method disclosed herein is not limited to the engine module(s) 607 being run locally on a single computing server 602 via the operating system and the processor(s) 603, but extends to running the engine module(s) 607 remotely over the network 601 by employing a web browser, one or more remote servers, computers, mobile phones, and/or other electronic devices. In an embodiment, one or more portions of the artificial intelligence-based platform 612 are distributed across one or more computer systems (not shown) coupled to the network 601. In another embodiment, one or more modules, databases, processing elements, memory elements, storage elements, etc., of the IUI surveillance system 100 disclosed herein are distributed across a cluster of computer systems (not shown), for example, computers, servers, virtual machines, containers, nodes, etc., coupled to the network 601, where the computer systems coherently communicate and coordinate with each other to share resources, distribute workload, and execute different portions of the logic to facilitate IUI surveillance.

The non-transitory, computer-readable storage medium disclosed herein stores computer program instructions executable by the processor 603 for facilitating IUI surveillance. The computer program instructions implement the processes of various embodiments disclosed above and perform additional steps that may be required and contemplated for facilitating IUI surveillance. When the computer program instructions are executed by the processor(s) 603, the computer program instructions cause the processor(s) 603 to perform the steps of the method for facilitating IUI surveillance as disclosed in the descriptions of FIGS. 1-5D. In an embodiment, a single piece of computer program code comprising computer program instructions performs one or more steps of the method disclosed in the descriptions of FIGS. 1-5D. The processor(s) 603 retrieves these computer program instructions and executes them.

A module, or an engine, or a unit, as used herein, refers to any combination of hardware, software, and/or firmware. As an example, a module, or an engine, or a unit includes hardware such as a microcontroller, associated with a non-transitory, computer-readable storage medium to store computer program codes adapted to be executed by the microcontroller. Therefore, references to a module, or an engine, or a unit, in an embodiment, refer to the hardware that is specifically configured to recognize and/or execute the computer program codes to be held on a non-transitory, computer-readable storage medium. In an embodiment, the computer program codes comprising computer readable and executable instructions are implemented on any platform or in any programming language, for example, JavaScript®, hypertext markup language (HTML), cascading style sheets (CSS), the Angular® framework, Python®, the Flask framework, Hadoop® of the Apache Software Foundation, etc. In an embodiment, the computer program codes are deployed on a cloud platform, for example, the Amazon Web Services (AWS®) platform or the Microsoft Azure® platform. In another embodiment, other object-oriented, functional, scripting, and/or logical programming languages are also used. In an embodiment, the computer program codes or software programs are stored on or in one or more mediums as object code. In another embodiment, the term “module” or “engine” or “unit” refers to the combination of the microcontroller and the non-transitory, computer-readable storage medium. Often module or engine or unit boundaries that are illustrated as separate commonly vary and potentially overlap. For example, a module or an engine or a unit may share hardware, software, firmware, or a combination thereof, while potentially retaining some independent hardware, software, or firmware. In various embodiments, a module or an engine or a unit includes any suitable logic.

The intelligent user interface (IUI) surveillance system 100 comprising the image capture devices 101a, 101b, and 101c and the artificial intelligence-based platform 612 with the image processing engine 102, the control unit 106, and the method disclosed herein provide an improvement in video surveillance. In the IUI surveillance system 100 and the method disclosed herein, the design and the flow of interactions between the image capture devices 101a, 101b, and 101c and the AI-based platform 612 and between the modules 102a to 102i of the image processing engine 102 are deliberate, designed, and directed. The images received by the image processing engine 102 are configured by the image processing engine 102 to steer the images towards a finite set of predictable outcomes. The image processing engine 102 implements one or more specific computer programs to direct the images towards a set of end results. The interactions designed by the image processing engine 102 allow the image processing engine 102 to receive an image stream from the cameras 101a, 101b, and 101c via the network 601; identify regions of interest in the image stream; determine multiple interest elements in the identified regions of interest in the image stream by selectively using one or more artificial intelligence modules 104 and from these interest elements, through the use of other, separate and autonomous computer programs, generate resultant data based on one or more conditions; and transmit the generated resultant data to the control unit 106 for selective rendering in one or more views on the IUI 107 for review and verification. Furthermore, the image processing engine 102 updates the artificial intelligence modules 104 and the resultant data based on tuning parameters and an identification of false positives received via the IUI 107, and transmits the updated resultant data to the control unit 106 for execution of response actions. To perform the above disclosed method steps requires multiple separate computer programs and subprograms, the execution of which cannot be performed by a person using a generic computer with a generic program.

The Intelligent User Interface (IUI) surveillance system 100 and the method disclosed herein disclose an improvement to artificial intelligence-enabled, computer-related functionality for facilitating IUI surveillance, and not on economic or other tasks for which a generic computer is used in its ordinary capacity. Accordingly, the IUI surveillance system 100 and the method disclosed herein are not directed to an abstract idea. Rather, the IUI surveillance system 100 and the method disclosed herein are directed to a specific improvement to the way the image processing engine 102 of the artificial intelligence-enabled platform 612 operates, embodied in, the method steps disclosed above. The evolving AI techniques implemented herein are based on repeated and continuous learning, training, and retraining of the artificial intelligence modules 104 including machine learning modules through dynamic real-time data, for example, feedback received from the IUISS user via the IUI 107.

It is apparent in different embodiments that the various methods, algorithms, and computer-readable programs disclosed herein are implemented on non-transitory, computer-readable storage media appropriately programmed for computing devices. The non-transitory, computer-readable storage media participate in providing data, for example, instructions that are read by a computer, a processor, or a similar device. In different embodiments, the “non-transitory, computer-readable storage media” also refer to a single medium or multiple media, for example, a centralized database, a distributed database, and/or associated caches and servers that store one or more sets of instructions that are read by a computer, a processor, or a similar device. The “non-transitory, computer-readable storage media” also refer to any medium capable of storing or encoding a set of instructions for execution by a computer, a processor, or a similar device and that causes a computer, a processor, or a similar device to perform any one or more of the steps of the method disclosed herein. In an embodiment, the computer programs that implement the methods and algorithms disclosed herein are stored and transmitted using a variety of media, for example, the computer-readable media in various manners. In an embodiment, hard-wired circuitry or custom hardware is used in place of, or in combination with, software instructions for implementing the processes of various embodiments. Therefore, the embodiments are not limited to any specific combination of hardware and software. Various aspects of the embodiments disclosed herein are implemented in a non-programmed environment comprising documents created, for example, in a hypertext markup language (HTML), an extensible markup language (XML), or other format that render aspects of a graphical user interface (GUI) or perform other functions, when viewed in a visual area or a window of a browser program. Various aspects of the embodiments disclosed herein are implemented as programmed elements, or non-programmed elements, or any suitable combination thereof.

Where databases are described such as the image database 102h, it will be understood by one of ordinary skill in the art that (i) alternative database structures to those described may be employed, and (ii) other memory structures besides databases may be employed. Any illustrations or descriptions of any sample databases disclosed herein are illustrative arrangements for stored representations of information. In an embodiment, any number of other arrangements are employed besides those suggested by tables illustrated in the drawings or elsewhere. In another embodiment, despite any depiction of the databases as tables, other formats including relational databases, object-based modules 104, and/or distributed databases are used to store and manipulate the data types disclosed herein. In an embodiment, object methods or behaviors of a database 102h are used to implement various processes such as those disclosed herein. In another embodiment, the databases 102h are, in a known manner, stored locally or remotely from a device that accesses data in such a database 102h. In embodiments where there are multiple databases 102h, the databases 102h are integrated to communicate with each other for enabling simultaneous updates of data linked across the databases 102h, when there are any updates to the data in one of the databases 102h.

The embodiments disclosed herein are configured to operate in a network environment comprising one or more computers that are in communication with one or more devices via a network 601. In an embodiment, the computers communicate with the devices directly or indirectly, via a wired medium or a wireless medium such as the Internet, satellite internet, a local area network (LAN), a wide area network (WAN) or the Ethernet, or via any appropriate communication medium or combination of communications mediums. Each of the devices comprises processors that are adapted to communicate with the computers. In an embodiment, each of the computers is equipped with a network communication device, for example, a network interface card, a modem, or other network connection device suitable for connecting to a network. Each of the computers and the devices executes an operating system. While the operating system may differ depending on the type of computer, the operating system provides the appropriate communications protocols to establish communication links with the network. Any number and type of machines may be in communication with the computers.

The embodiments disclosed herein are not limited to a particular computer system platform, processor, operating system, or network 601. One or more of the embodiments disclosed herein are distributed among one or more computer systems, for example, servers configured to provide one or more services to one or more client computers, or to perform a complete task in a distributed system. For example, one or more of embodiments disclosed herein are performed on a client-server system that comprises components distributed among one or more server systems that perform multiple functions according to various embodiments. These components comprise, for example, executable, intermediate, or interpreted code, which communicate over a network 601 using a communication protocol. The embodiments disclosed herein are not limited to be executable on any particular system or group of systems, and are not limited to any particular distributed architecture, network, or communication protocol.

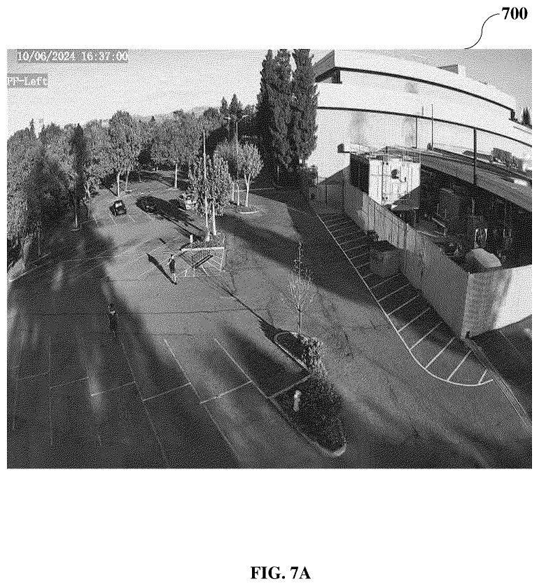

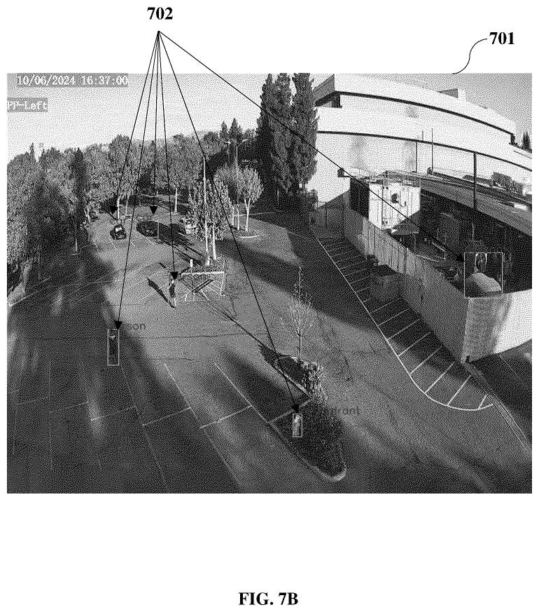

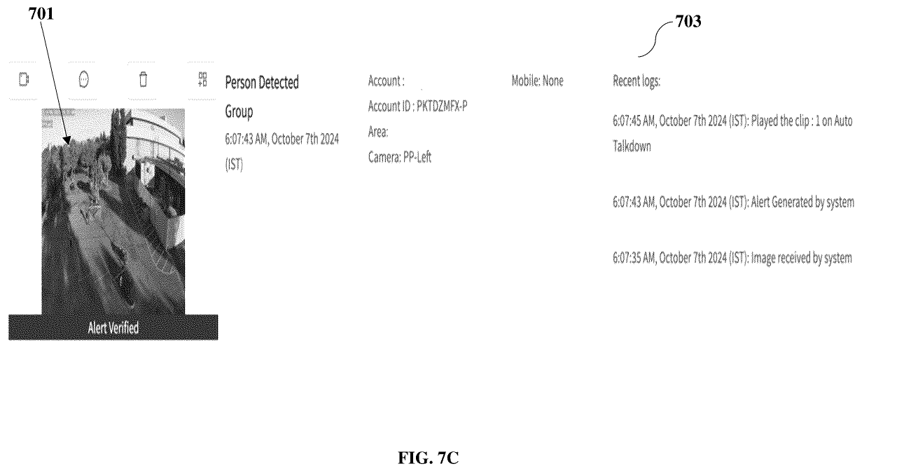

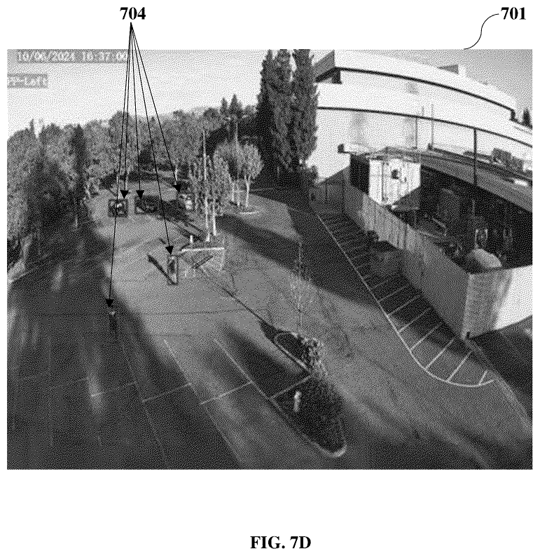

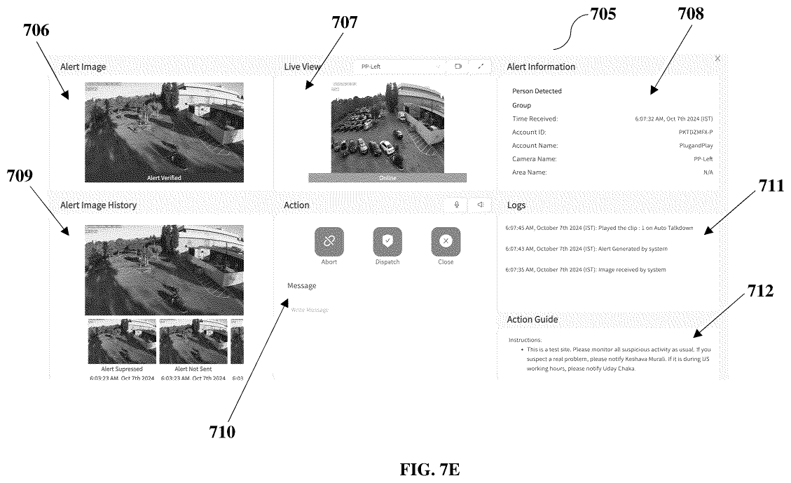

FIGS. 7A-7E illustrate screenshots of an image stream captured by video surveillance cameras and an intelligent user interface (IUI) 107 configured for rendering a comprehensive view facilitating intelligent user interface (IUI) surveillance. In this example the IUI surveillance system 100 is implemented as a video surveillance system 100. The video surveillance system 100 comprises multiple video cameras 101a, 101b, 101c, a motion filtering and preprocessing module 103, an artificial intelligence module 104 comprising a machine learning module 104, a UI, and an alerting system. The IUI surveillance system 100 provides a user-friendly Graphical User Interface (GUI) 107, herein referred to as the IUI 107, for example, for account creation, account management, camera association with an account, speaker and light association, camera and speaker settings, recording messages to be played at speakers, preprocessing settings, artificial intelligence settings, and post-processing settings. The IUI surveillance system 100 also provides the IUI 107, for example, for live view monitoring, viewing history, live alert monitoring, alert history viewing, alert response standard operating procedure (SOP) editing, alert response SOP viewing, alert response viewing, alert response history viewing, alert response analytics, external response settings, external response monitoring, external response analytics, etc., as described in the detailed description of FIGS. 4A-4R.

The video cameras 101a, 101b, 101c are configured to capture video frames from a surveillance site 700, such as, a parking lot, as exemplarily illustrated in FIG. 7A. The motion filtering and preprocessing module 103 employs a combination of inter-frame pixel value differencing, region-wise aggregation of differences, and a two dimensional (2-D) Fourier transform algorithms, to process the captured video frames to identify video frames containing motion. For example, the motion filtering and preprocessing module 103 performs basic motion detection by analyzing pixel differences between consecutive video frames. The motion filtering and preprocessing module 103 further enhances the motion detection by using information from three consecutive video frames and processing their 2-D Fourier transforms for robust frame differencing that rejects false alarms in frame differences due to rain, snow, and changing light.

The machine learning module 104 comprising an object detection neural network is trained to analyze the captured video frames 700 identified by the motion filtering and preprocessing module 103, and detect and classify objects 702 within the captured video frames, for example, as persons or vehicles, as exemplarily illustrated in FIG. 7B. The object detection neural network is custom trained on a proprietary dataset of video frames labeled with objects classified, for example, as persons and vehicles. Furthermore, the custom trained object detection neural network does not forget the information gained from previous training dataset, while learning the new training dataset. The object detection neural network draws object boxes over the detected and classified objects 702 within the captured video frames 701, as exemplarily illustrated in FIG. 7B. As used herein, the term ‘object box’ refers to a rectangle that surrounds an object of interest in an image or video frame. In an embodiment, a IUISS user can configure or customize bounding box limits, such as, view-specific limits, region-specific limits, geometric limits, and object-specific limits, etc., for each video camera 101a, 101b, 101c and region of interest within the surveillance area. During post-processing the intelligent user interface surveillance system 100 removes false alarms in object detection based on view-specific and region-specific object box size limits, regions of interest masks, and regions of disinterest masks, and detection probability thresholds. Furthermore, any object box detected outside the region of interest or in the region of disinterest is removed.

Upon detecting motion by the machine learning module 104, the IUI 107 is set to display an alert display page 703 displaying a video frame 701 containing detected objects and showing the nature of an interest element, for example, a person, a vehicle, or a fire hydrant detected, an account name: XYZ and an account identifier (ID): PKTDZMFX-P, an area number, camera view: PP-Left, name of a person to be contacted, recent logs from that camera view, and controls to respond to the generated alerts, as exemplarily illustrated in FIG. 7C. Upon analyzing the nature of an interest element in the video frame 701, the alerting system generates an alert and plays a message on speakers installed at a site where the video camera 101a, 101b, 101c is installed to desist an intruder. Furthermore, the alert display page 703 lists recent logs from that camera view, for example, 1) 6:07:45AM, Oct. 7, 2024 (IST): Played the clip: 1 on Auto Talkdown; 2) 6:07:43AM, Oct. 7, 2024 (IST): Alert Generated by system; 3) 6:07:43AM, Oct. 7, 2024 (IST): Image received by the system, as exemplarily illustrated in FIG. 7C. Upon detecting motion, if the detected objects in the video frame 701 are outside the region of interest or within the region of disinterest, the intelligent user interface (IUI) surveillance system 100 removes the detected objects during post-processing. Region of disinterest can also be used to suppress false positives in areas of spurious motions such as reflections, shadows and moving branches. FIG. 7D exemplarily illustrates an enlarged view of the video frame 701 with the detected objects 704 that are of no interest and need to be removed. FIG. 7E exemplarily illustrates a screenshot of an alert processing page 705 displaying a post-processed image shown in the live portal for user-in-the-loop monitoring 706, a live view panel 707, an alert information panel 708, an alert image history panel 709, an action panel 710, a logs panel 711, and an action guide 712.

The IUI surveillance system 100 is designed to reduce false positives with each additional stage in the pipeline, without incurring false negatives at any stage. During post-processing, each stage in the pipeline is configured to not miss events or changes or movements of potential interest. At the same time, each stage in the pipeline is further configured to reduce/filter out the events or changes or movements of disinterest, thereby minimizing false detection passed to the next stage. Furthermore, the IUI surveillance system 100 applies the post-processing logic to the outputs generated by neural network before sending an alert to the monitors i.e., IUISS user. This post-processing further filters out false positives in the pipeline, and sending all events of interest and very few false positives to the monitor. This contrasts with typical artificial intelligence (AI) systems that have fewer or poorly designed stages, which tend to generate a higher number of false positives. As a result, the IUI surveillance system 100 allows the monitor to curate alerts from multiple cameras 101a, 101b, 101c than would be possible in a purely manual monitoring process or in systems using only AI modules 104, all without missing events of interest.

The monitors manually and efficiently verify and filter out the remaining false positives among events of interest using IUI 107, which allows the monitors to put the alert in the context of previous activity at the same camera 101a, 101b, 101c, as well as corresponding feeds from other cameras 101a, 101b, 101c located in the same area. Only after the monitor ratifies the AI-generated alert, the alert is dispatched for talk-down or lights and sound, or AI-based guard persona or on-ground security guards to deter the intruder. The IUI surveillance system 100 along with carefully designed pipeline significantly reduces false positives without incurring false negatives, compared to simpler AI surveillance systems, and surveillance systems that rely solely on AI modules 104 or solely on monitors.

The foregoing examples and illustrative implementations of various embodiments have been provided merely for explanation and are in no way to be construed as limiting the embodiments disclosed herein. While the embodiments have been described with reference to various illustrative implementations, drawings, and techniques, it is understood that the words, which have been used herein, are words of description and illustration, rather than words of limitation. Furthermore, although the embodiments have been described herein with reference to particular means, materials, techniques, and implementations, the embodiments herein are not intended to be limited to the particulars disclosed herein; rather, the embodiments extend to all functionally equivalent structures, methods and uses, such as are within the scope of the appended claims. It will be understood by those skilled in the art, having the benefit of the teachings of this specification, that the embodiments disclosed herein are capable of modifications and other embodiments may be effected and changes may be made thereto, without departing from the scope and spirit of the embodiments disclosed herein.

1. An artificial intelligence-assisted surveillance system comprising:
one or more image capture devices configured to capture and selectively transmit an image stream associated with a surveillance area via a network;
at least one computing server in operable communication with the one or more image capture devices, the at least one computing server comprising:
at least one processor;
a memory unit operably and communicatively coupled to the at least one processor and configured to store computer program instructions, the image stream, and metadata associated with the image stream;
an image processing engine defining the computer program instructions, which when executed by the at least one processor, cause the at least one processor to:
receive the image stream of the surveillance area from the one or more image capture devices, by a motion filtering and pre-processing module of the image processing engine, via the network;
identify regions of interest and regions of disinterest in the image stream, by a motion filtering and pre-processing module of the image processing engine, wherein the regions of interest comprise regions of significant motion, and regions of disinterest comprise regions outside physical boundaries of the surveillance area, and wherein the regions of interest and the regions of disinterest are one or more of user-specified or auto-suggested by an artificial intelligence system comprising neural networks that recognize the regions of interest and the regions of disinterest of the surveillance area;
determine a plurality of interest elements in the identified regions of interest in the image stream by selectively using one or more of a plurality of artificial intelligence modules, and categorize the determined plurality of interest elements; and
generate resultant data based on the determined and categorized plurality of interest elements and one or more of a plurality of conditions, by the plurality of artificial intelligence modules of the image processing engine;
a control unit in operable communication with the image processing engine, wherein the control unit is configured to receive the generated resultant data from the image processing engine and selectively render the generated resultant data in one or more views on an user interface for review and verification by a user; and
said user interface, in operable communication with the control unit, configured to:
accept a user input comprising tuning parameters for:
the one or more image capture devices;
the identification of the regions of interest and regions of disinterest;
the determination of the plurality of interest elements; and
the plurality of artificial intelligence modules;
said control unit configured to accept from the user only confirmed false positives from out of the false positives generated by the plurality of artificial intelligence modules;
said control unit configured to accept a refined selectively rendered resultant data from the user, wherein the refined selectively rendered resultant data is used to eliminate generation of false positives in future by the plurality of artificial intelligence modules;
said control unit configured to communicate the received tuning parameters and the refined selectively rendered resultant data to the image processing engine;
said image processing engine configured to update the plurality of artificial intelligence modules and the resultant data based on the received tuning parameters and the refined selectively rendered resultant data; and
said image processing engine configured to communicate the updated resultant data to the control unit, wherein the control unit is configured to execute response actions based on the updated resultant data.

2. The artificial intelligence-assisted surveillance system of claim 1, wherein the motion filtering and pre-processing module of the image processing engine identifies the regions of significant motion and reduces false positives detected by onboard processing performed by the image capture devices.

3. The artificial intelligence-assisted surveillance system of claim 1, wherein the motion filtering and pre-processing module of the image processing engine:
employs a plurality of motion detection techniques comprising one or more of utilization of two-dimensional Fourier transforms or other transforms, histogram equalization, shape analysis of areas of significant pixel value difference between image frames, inter-frame pixel value differencing, and region-wise aggregation of differences, for refined motion detection;
enhances motion detection by using information from three consecutive image frames and processes the two-dimensional Fourier transforms for robust frame differencing that rejects false alarms in frame differences due to rain, snow, and changing light; and
performs image frame enhancement comprising one or more of noise reduction, contrast enhancement, region-adaptive contrast enhancement, and brightness adaptation to improve image quality for improving performance of the plurality of artificial intelligence modules.

4-5. (canceled)

6. The artificial intelligence-assisted surveillance system of claim 1, wherein the image stream is securely proxied through a cloud server and converted to an enhanced display format, wherein the plurality of interest elements in the identified regions of interest in the image stream comprises faces, humans, animals, vehicles, objects, markers, and events, wherein the image capture device captures and transmits a burst of image frames to the motion filtering and preprocessing module upon detecting motion, and wherein the motion filtering and preprocessing module processes the received burst of frames using two-dimensional Fourier transforms to filter out spurious motion alerts.

7. The artificial intelligence-assisted surveillance system of claim 6, wherein the frames filtered for motion are input into convolutional neural networks or transformer networks of the plurality of artificial intelligence modules of the image processing engine for detection of the humans and the vehicles, and wherein if the humans or vehicles are detected, the frames filtered for motion are further input into a video analysis neural network of the plurality of artificial intelligence modules of the image processing engine for event and behavior detection or an event or behavior is detected based on hard-coded rules applied to detection of objects, location of objects, their motion in time, and confidence scores of the detected objects to detect events of interest.

8. The artificial intelligence-assisted surveillance system of claim 1, wherein the post-processing module of the image processing engine removes one or more objects detected outside the identified region of interest, and removes objects detected within the identified region of disinterest.

9. (canceled)

10. The artificial intelligence-assisted surveillance system of claim 1, wherein the plurality of conditions comprises configurable thresholds associated with overlaps between the plurality of interest elements and the identified regions of interest, location of the interest elements, size of the interest elements, type of the interest elements, number of the interest elements, time period of detections of the interest elements, configurable schedules, field of view changes, and preferences of the user.

11. The artificial intelligence-assisted surveillance system of claim 1, wherein the generated resultant data comprises the identified regions of interest, the identified regions of disinterest, the determined interest elements, actionable alerts, the tuning parameters, alert history, alert response history, alert response standard operating procedures, alert response statistics, and information about behavior of an external response system.

12. The artificial intelligence-assisted surveillance system of claim 1, wherein the user interface is configured to generate and render a comprehensive view of the image stream on a display unit, wherein the rendered comprehensive view of the image stream comprises real-time image frames with highlighted interest elements, and an alert history extracted from the resultant data, and wherein the user interface comprises multiple portals or applications serving an administrator, a remote monitoring agent, the user, and on-premises guard.

13. The artificial intelligence-assisted surveillance system of claim 1, wherein the user interface comprises a plurality of user interface elements, wherein a first user interface element from among the plurality of user interface elements is configured to allow a user to define regions of interest and regions of disinterest within the surveillance area to reduce the false positives, and wherein a second user interface element from among the plurality of user interface elements is configured to allow the user to annotate and correct regions of interest and disinterest.

14. The artificial intelligence-assisted surveillance system of claim 11, wherein the control unit is further configured to transmit selected actionable alerts associated with the updated resultant data to an external response system for deterrence of intrusion, and wherein the selected actionable alerts comprise alerts, signals, and audio messages, and wherein the external response system comprises one or more of audio speakers, alarms, sirens, lights, security personnel and remote monitoring agents assigned to remotely monitor the one or more image capture devices, the selected actionable alerts, and at least part of the updated resultant data for executing the response actions.

15. (canceled)

16. The artificial intelligence-assisted surveillance system of claim 15, further comprising a mobile application deployable on a user device for monitoring location and the response actions of the security personnel, wherein the response actions comprises rendering alert notifications in a plurality of modes via alerting devices, and wherein the plurality of modes comprises a text mode, an electronic mail mode, an audio mode, a voice mode, a light mode, an artificial intelligence-generated mode, a real-time notification mode, media playback mode, and a push-to-talk mode.

17-19. (canceled)

20. A method employing an image processing engine defining computer program instructions executable by at least one processor for facilitating artificial intelligence-assisted surveillance, the method comprising:
receiving an image stream of a surveillance area from one or more image capture devices via a network, by a motion filtering and pre-processing module of the image processing engine;
identifying regions of interest and regions of disinterest in the image stream, by the motion filtering and pre-processing module of the image processing engine, wherein the regions of interest comprise regions of significant motion, and regions of disinterest comprise regions outside physical boundaries of the surveillance area, wherein the regions of interest and the regions of disinterest are one or more of user-specified or auto-suggested by an artificial intelligence system comprising neural networks that recognize the regions of interest and the regions of disinterest of the surveillance area;
determining a plurality of interest elements in the identified regions of interest in the image stream, by selectively using one or more of a plurality of artificial intelligence modules in the image processing engine, and categorizing the determined plurality of interest elements;
generating resultant data based on the determined and the categorized plurality of interest elements and one or more of a plurality of conditions, by the plurality of artificial intelligence modules in the image processing engine;
communicating the generated resultant data to a control unit, by a post-processing unit of the image processing engine, for selective rendering in one or more views on an user interface for review and verification by a user, wherein the user interface is configured to:
accept a user input comprising tuning parameters for:
the one or more image capture devices;
the identification of the regions of interest and regions of disinterest;
the determination of the plurality of interest elements; and
the plurality of artificial intelligence modules;
accepting only confirmed false positives from out of the false positives generated by the plurality of artificial intelligence modules from the user, by the control unit;
accepting from the user, by the control unit, a refined selectively rendered resultant data, wherein the refined selectively rendered resultant data is used to eliminate generation of the false positives in future by the plurality of artificial intelligence modules;
communicating the received tuning parameters and the refined selectively rendered resultant data to the image processing engine, by the control unit;
updating the artificial intelligence modules and the resultant data based on the received tuning parameters and the refined selectively rendered resultant data, by the image processing engine; and
communicating the updated resultant data to the control unit, by the image processing engine, wherein the control unit is configured to execute response actions based on the updated resultant data.

21. The method of claim 20, wherein the motion filtering and pre-processing module of the image processing engine identifies the regions of significant motion and reducing false positives detected by onboard processing performed by the image capture devices.

22. The method of claim 20, wherein the motion filtering and pre-processing module of the image processing engine:
employs a plurality of motion detection techniques comprising one or more of utilization of two-dimensional (2-D) Fourier transforms or other transforms, histogram equalization, shape analysis of areas of significant pixel value difference between image frames, inter-frame pixel value differencing, and region-wise aggregation of differences, for refined motion detection;
enhances motion detection by using information from three consecutive image frames and processes the two-dimensional Fourier transforms for robust frame differencing that rejects false alarms in frame differences due to rain, snow, and changing light; and
performs image frame enhancement comprising one or more of noise reduction, contrast enhancement, region-adaptive contrast enhancement, and brightness adaptation to improve image quality for improving performance of the artificial intelligence modules.

23-24. (canceled)

25. The method of claim 20, wherein the image stream is securely proxied through a cloud server and converted to an enhanced display format, wherein the plurality of interest elements in the identified regions of interest in the image stream comprises faces, humans, animals, vehicles, objects, markers, and events, wherein the image capture device captures and transmits a burst of image frames to the motion filtering and preprocessing module upon detecting motion, and wherein the motion filtering and preprocessing module processes the received burst of frames using two-dimensional Fourier transforms to filter out spurious motion alerts.

26. The method of claim 25, wherein frames filtered for motion are input into convolutional neural networks or transformer networks of the plurality of artificial intelligence modules of the image processing engine for detection of the humans and the vehicles, and wherein if the humans or vehicles are detected, the frames filtered for motion are further input into a video analysis neural networks of the plurality of artificial intelligence modules of the image processing engine for event and behavior detection or an event or behavior is detected based on hard-coded rules applied to detection of objects, location of objects, their motion in time, and confidence scores of the detected objects to detect events of interest.

27. The method of claim 20, wherein the post-processing module of the image processing engine removes objects detected outside the identified region of interest or in the regions of disinterest.

28. The method of claim 20, wherein the plurality of conditions comprises configurable thresholds associated with overlaps between the plurality of interest elements and the identified regions of interest, location of the interest elements, size of the interest elements, type of the interest elements, number of the interest elements, time period of detections of the interest elements, configurable schedules, field of view changes, and preferences of the user.

29. The method of claim 20, wherein the generated resultant data comprises the identified regions of interest, the identified regions of disinterest, the determined interest elements, actionable alerts, the tuning parameters, alert history, alert response history, alert response standard operating procedures, alert response statistics, and information about behavior of an external response system.

30. (canceled)
